(19) United States
(12) Patent Application Publication
(10) Pub. No.: US 2025/0247885 A1
(43) Pub. Date: Jul. 31, 2025

(54) RANDOM RESOURCE SELECTION PROCEDURES FOR AMBIENT IOT SYSTEMS

(71) Applicant: Samsung Electronics Co., Ltd., Suwon-si (KR)

(72) Inventors: Yaser Mohamed Mostafa Kamal FOUAD, San Diego, CA (US); Youn Hyoung HEO, San Jose, CA (US); Yuhan ZHOU, San Diego, CA (US); Philippe Jean Marc Michel SARTORI, Naperville, IL (US)

(21) Appl. No.: 19/021,039

(22) Filed: Jan. 14, 2025

Related U.S. Application Data
(60) Provisional application No. 63/625,841, filed on Jan. 26, 2024.

(51) Int. Cl. H04W 74/0816; H04W 72/0446; H04W 72/0453

(52) U.S. Cl. CPC H04W 74/0816; H04W 72/0446; H04W 72/0453

(57) ABSTRACT

A method includes: receiving, by a processor, a transmission comprising a channel sensing metric associated with a communication resource within a communication network for a plurality of wireless devices, wherein the plurality of wireless devices comprises ambient Internet of Things (IoT) devices; determining, by the processor, whether establishing a communication link with the communication resource comprises a collision with one of the plurality of wireless devices in the communication network based on the received channel sensing metric; selecting, by the processor, the communication resource based on the determination; and establishing, by a processor, the communication link using the selected communication resource.

### CROSS-REFERENCE TO RELATED APPLICATION

The present application claims the priority benefit under 35 U.S.C. § 119 (e) of U.S. Provisional Application No. 63/625,841, filed on Jan. 26, 2024, the disclosure of which is incorporated by reference in its entirety as if fully set forth herein.

### BACKGROUND

### 1. Field

The disclosure generally relates to wireless communication systems. More particularly, the subject matter disclosed herein relates to improvements to resource selection and/or allocation.

### 2. Description of the Related Art

Medium access procedures may refer to processes that enable Internet of Things (IoT) devices to share and/or access a communication channel (e.g., medium) utilized to send and/or receive data over a network. Medium access procedures that are utilized for ambient IoT devices and/or systems may be impacted by collisions. For example, if collisions occur between physically proximate ambient IoT devices, then transmissions may not be properly decoded at the source. This issue may be exacerbated in the case of ambient IoT systems, because some of the transmissions may rely on backscattering with limited power amplification. Therefore, it may be important to develop efficient random-based resource allocation (and/or random-based resource selection) procedures for ambient IoT systems.

The above information disclosed in this Background section is for enhancement of understanding of the background of the present disclosure, and therefore, it may contain information that does not constitute prior art.

### SUMMARY

The robustness of random resource selection and/or allocation techniques have not been leveraged for ambient IoT devices, in accordance with some wireless communication technology standards, in a manner that ensures flexibility, mobility, reliability and high-performance connectivity for a wide-range of wireless applications and user devices.

Aspects of some embodiments of the present disclosure relate to systems and methods that may be capable of implementing random resource selection and/or allocation functions for ambient IoT devices. The random resource selection and/or allocation functions may modify medium access procedures in a manner that is optimal for the capabilities of ambient IoT device to reduce collisions and accordingly allow large numbers of low complexity devices to perform transmissions efficiently. Thus, the disclosed embodiments may improve the efficiency, range, and overall performance of a wireless communication network through achieving an optimized random resource selection.

According to some embodiments of the present disclosure, a method includes: receiving, by a processor, a transmission comprising a channel sensing metric associated with a communication resource within a communication network for a plurality of wireless devices, wherein the plurality of wireless devices comprises ambient Internet of Things (IoT) devices; determining, by the processor, whether establishing a communication link with the communication resource comprises a collision with one of the plurality of wireless devices in the communication network based on the received channel sensing metric; selecting, by the processor, the communication resource based on the determination; and establishing, by a processor, the communication link using the selected communication resource.

According to some embodiments, the received channel sensing metric comprises a channel busy ratio (CBR) value received from an intermediate node.

According to some embodiments, the method further includes measuring the communication resource to obtain a measured CBR value.

According to some embodiments, the measuring the communication resource further comprises utilizing a pre-configured CBR value in response to the measured CBR value being insufficient or unavailable.

According to some embodiments, the determining is based on a priority-based threshold and a selected CBR selected from the group consisting of the received CBR value, the measured CBR value, and the pre-configured CBR value.

According to some embodiments, the method further includes transmitting, on the established link using the selected communication resource, an uplink signal during a first time slot and an energy signal during a second time slot.

According to some embodiments, the transmitting of the energy signal comprises intermittently transmitting the energy signal in the second time slot based on the priority of the wireless device, wherein a wireless device having a highest priority has a longest transmission duration of the energy signal in the second time slot.

According to some embodiments, the method further includes transmitting an uplink signal or repetitions of the uplink signal by switching the selected communication resource to a new carrier frequency.

According to some embodiments, the information comprises an indication of the communication resource being reserved by a wireless device within the communication network based on the wireless device transmitting a future reservation associated with the communication resource to a source device, wherein the selected communication resource is based on the communication resource not being reserved by the wireless device.

According to some embodiments, the method further includes reselecting a different communication resource based on the indication and transmitting an uplink signal on the established communication link using the reselected communication resource.

According to some embodiments, the method further includes transmitting an uplink signal on the established communication link using the selected communication resource based on an association between a downlink signal and a downlink resource with the uplink backscattered signal and an uplink resource, wherein the transmission comprises additional information comprising the association.

According to some embodiments, the transmission comprises additional information including an indication of previously detected devices from the plurality of wireless devices in the communication network.

According to some embodiments, transmitting an uplink signal comprising a reduced payload on the established communication link using the selected communication resource and based on the received indication, wherein the reduced payload comprises a data sequence.

According to some embodiments, previously detected devices transmit a reduced payload or do not transmit based on the indication.

According to some embodiments, the method further includes randomly selecting multiple resources for transmitting repetitions of a transfer block based on the channel sensing metric.

According to some embodiments, the method further includes including an indication of the resources used to transmit each of the multiple repetitions of the transmitted transfer block.

According to some embodiments, the method further includes performing successive interference cancellation based on the indication and receiving a repetition of the transfer block.

According to some embodiments, the communication resource includes a time slot and/or a carrier frequency.

According to some embodiments of the present disclosure, a device includes: one or more processors that are configured to perform: receiving a transmission comprising a channel sensing metric associated with a communication resource within a communication network for a plurality of wireless devices, wherein the plurality of wireless devices comprises ambient Internet of Things (IoT) devices; determining whether establishing a communication link with the communication resource comprises a collision with one of the plurality of wireless devices in the communication network based on the received channel sensing metric; selecting the communication resource based on the determination; and establishing the communication link using the selected communication resource.

According to some embodiments of the present disclosure, a non-transitory computer readable storage medium stores instructions which, when executed by a processor, cause the processor to perform operations comprising: receiving a transmission comprising a channel sensing metric associated with a communication resource within a communication network for a plurality of wireless devices, wherein the plurality of wireless devices comprises Internet of Things (IoT) devices; determining whether establishing a communication link with the communication resource comprises a collision with one of the plurality of wireless devices in the communication network based on the received channel sensing metric; selecting the communication resource based on the determination; and establishing the communication link using the selected communication resource.

### BRIEF DESCRIPTION OF THE DRAWINGS

In the following section, the aspects of the subject matter disclosed herein will be described with reference to exemplary embodiments illustrated in the figures, in which:

FIG. 1 depicts an example wireless network system configured to implement random resource allocation for ambient Internet of Things (IoT) devices, according to some embodiments.

FIG. 2 is a block diagram depicting an example ambient IoT device implementing a random resource allocation circuit, according to some embodiments of the present disclosure.

FIG. 3 depicts an example random resource allocation for an ambient IoT device based on channel-based measurements, according to embodiments of the present disclosure.

FIG. 4 depicts an example of controlling transmission based on channel-based measurements using random resource allocation for an ambient IoT device, according to some embodiments of the present disclosure.

FIG. 5 depicts an example of carrier/slot hopping using random resource allocation for an ambient IoT device, according to some embodiments of the present disclosure.

FIG. 6 depicts an example of intermittent sensing and transmissions using random resource allocation for an ambient IoT device, according to some embodiments of the present disclosure.

FIG. 7 depicts an example of successive interference cancellation using random resource allocation for an ambient IoT device, according to some embodiments of the present disclosure.

FIG. 8 is a flowchart illustrating a method for successive interference cancellation at a source using random resource allocation for an ambient IoT device, according to some embodiments of the present disclosure.

FIG. 9 is a flowchart illustrating a method for successive interference cancellation at an ambient IoT device using random resource allocation for an ambient IoT device, according to some embodiments of the present disclosure.

FIG. 10 depicts an example of beamforming using random resource allocation for an ambient IoT device, according to some embodiments of the present disclosure.

FIG. 11 depicts an example of guided random resource selection using random resource allocation for an ambient IoT device, according to some embodiments of the present disclosure.

FIG. 12 depicts an example of resources association using random resource allocation for an ambient IoT device, according to some embodiments of the present disclosure.

FIG. 13 depicts another example of resources association using random resource allocation for an ambient IoT device, according to some embodiments of the present disclosure.

FIG. 14 depicts an example of reduced signaling using random resource allocation for an ambient IoT device, according to some embodiments of the present disclosure.

FIG. 15 illustrates a system including a user equipment (UE) and a base station (gNB) in communications with each other.

FIG. 16 is a block diagram of an electronic device in a network environment, according to some embodiments of the present disclosure.

### DETAILED DESCRIPTION

In the following detailed description, numerous specific details are set forth in order to provide a more thorough understanding of embodiments according to the present disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures (including component diagrams) shown and discussed herein are for illustrative purpose only and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions (e.g., stored in a non-transitory computer-readable storage medium), and the term “hardware,” as used in any implementation described herein, may include, for example, singly or in any combination, an assembly, hardwired circuitry, programmable circuitry, state machine circuitry, computer-readable storage medium, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Wireless communication systems including IoT devices, such as ambient IoT devices, may include a large number of low complex devices that are communicating with the source simultaneously. There are some wireless communication systems that may include IoT devices that may either communicate directly with the gNB or through an intermediate node. Thus, wireless communication systems including IoT devices may be able to support a wide range of applications. However, there can be several factors associated with such IoT-based wireless communication environments, such as a significantly large number of communicating IoT devices, close physical proximity between IoT devices, and the limited capabilities of IoT devices, that may cause frequent collisions between transmissions, thus impeding the overall performance of wireless communication systems for IoT devices.

Medium access procedures that are utilized for ambient IoT systems may also be impacted by collisions. As referred to herein, medium access procedures may refer to processes that enable IoT devices to share and/or access a communication channel (e.g., medium) utilized to send and/or receive data over a network. For example, if collisions occur between neighboring ambient IoT devices, then transmissions may not be properly decoded at the source. This issue may be exacerbated in the case of ambient IoT systems, because some of the UL transmissions may rely on backscattering with limited power amplification. Therefore, it may be important to develop efficient random-based resource allocation (and/or random-based resource selection) procedures for ambient IoT systems.

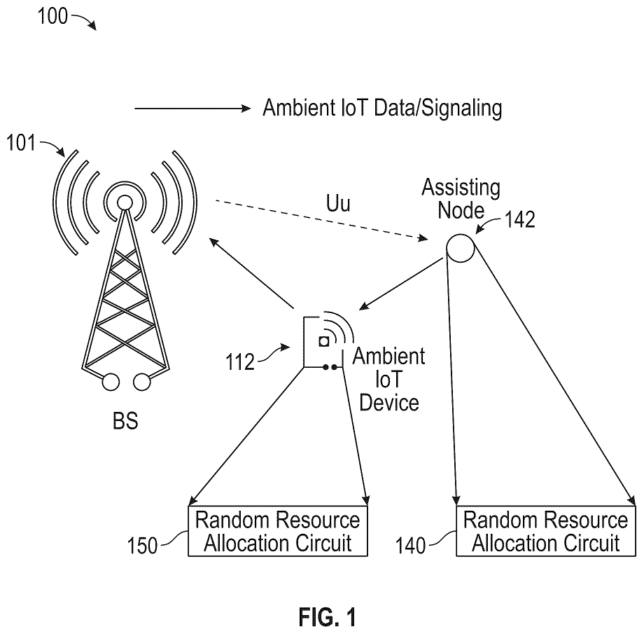

FIG. 1 depicts an example wireless network system 100 configured to implement random resource allocation for ambient IoT devices, according to some embodiments.

As illustrated in FIG. 1, the wireless network 100 may include a base station (BS) also referred to herein as general Nodes B (gNB), shown as a gNB 101. The gNB 101 may also communicate with at least one Internet Protocol (IP) network, such as the Internet, a proprietary IP network, or other data network. Instead of gNB, a component may also be referred to herein as an enhanced Node B (eNB). Depending on the network type, other terms can be used instead of gNB or BS, such as “access point” and/or the like. As used herein, “gNB” may refer to a network infrastructure component that provide wireless access to remote terminals.

Also, the wireless network 100 may include an ambient Internet of Things (IoT) device 112 in communication with the gNB 101. As used herein, an “ambient IoT device” may refer to a low power, wirelessly connectable device that that may operate in a background (ambient environment), collecting and transmitting data autonomously (e.g., without requiring direct user interaction). The ambient IoT device 112 may be energy-efficient, and battery-less, using energy harvesting technique for power from ambient sources including radio waves, light, and/or temperature changes. The ambient IoT device 112 may have the capability to operate autonomously for a long time period, and may be embedded in objects such as labels, packaging, sensors, wearables, and/or the like; and may be configured for various wireless applications such as smart packing, asset tracking, smart homes and building, wearables (e.g., health monitoring devices), and/or the like. The wireless network 100, in some cases, may include a substantially large number of ambient IoT devices, such as ambient IoT device 112 that are deployed in the field. Hence, ambient IoT devices may be cheaper than narrowband IoT devices and may be simpler than NB-IoT. In some cases, ambient IoT devices, such as ambient IoT device may be categorized by a device type according to factors including energy storage capacity, RF signals generation, transmissions, and/or the like. The device types for ambient IoT devices, in accordance with a wireless communication technology standard, may include: device type A having no energy storage, no independent signal generation/amplification (e.g., backscattering transmission); device type B having energy storage, no independent signal generation (e.g., backscattering transmission), and use of stored energy can include amplification for reflected signals; and device type C having energy storage, independent signal generation (e.g., active RF components for transmission).

The ambient IoT device 112 may be configured to operate in different environments (e.g., outdoor and indoor) and may support a wide range of communication distances (e.g., large distances for outdoor and small distances for indoor applications). Accordingly, wireless network 100 may support various communication topologies in accordance with a wireless communication technology standard (e.g., 3GPP) to enable the ambient IoT device 112 to communicate within the network 100. In some embodiments, the ambient IoT device 112 may directly communicate with the gNB 101 as a source. The communication between the ambient IoT device 112 and the gNB 101 may be bidirectional and direct (e.g., with no assistance node in between).

FIG. 1 illustrates an intermediate node 142 that may facilitate the communication between an ambient IoT device 112 and the gNB 101. The intermediate node 142 may be implement as a wireless component including a user equipment (UE), a relay, a repeater, gNB, and/or the like. The communication between the ambient IoT device 112 and the intermediate node 142 may be bidirectional. In some embodiments, the communication with the intermediate node 142 may not be bidirectional. For example, in case of uplink (UL) transmission assistance, the ambient IoT device 110 may receive a downlink (DL) communication directly from the gNB 101 while sending the UL communication through the intermediate node 142. In some embodiments, the ambient IoT device 112 may be able to support bidirectional communication directly between the intermediate node 142 (e.g., with no base station involvement), for example a UE.

The gNB 101 may implement a transmit (TX) path that is analogous to transmitting in the downlink (DL) to the ambient IoT device 112 and/or the intermediate node 142, and may implement a receive (RX) path that is analogous to receiving in the uplink from ambient IoT device 112 and/or the intermediate node 142. In an operational example, the gNB 101 may perform DL transmissions to the ambient IoT device 112 in a coverage area. For example, DL transmission from the gNB 101 may involve transmitting data and/or control signals to be received by the ambient IoT device 112 over a wireless channel, in accordance with one or more wireless communication protocols. DL communication may be utilized for delivering data and/or control signals from the network (e.g., gNB) to the ambient IoT device 112 to support several services and/or applications for ambient IoT devices.

The ambient IoT device 112 may implement the TX path for transmitting in the uplink (UL) to the gNB 101 and may implement the RX path for receiving in the DL from the gNB 101. In another operational example, the ambient IoT device 112 may be in the coverage area of the gNB 101 and may perform UL transmissions to the gNB 101. As an example, an UL transmission from the ambient IoT device 112 may involve transmitting data and/or control signals to be received by the gNB 101 over a wireless channel in accordance with one or more wireless communication protocols. The UL communication may be utilized for transmitting data, for example, and maintaining the connections with the gNBs 101-103 through signaling and feedback.

In some real-world applications for ambient IoT devices, the wireless network 100 may include large numbers of low complexity devices (e.g., IoT devices, ambient IoT device, etc.) that may attempt to simultaneously communicate. For example, there may be a plurality of ambient IoT devices that may be located physically proximate to the ambient IoT device 112 in the wireless network 100. Many of these nearby ambient IoT devices may attempt to perform UL transmissions, to the gNB 101 for example, at the same time as the ambient IoT device 112. Given the limited capabilities and the strict energy constraints of these devices, it may be desirable to utilize random resource allocation procedures to simplify resource selections. However, as large numbers of devices attempt to simultaneously connect to the system 100, the potential of collisions may increase substantially. Therefore, there is a need for methods to reduce the number of collisions for random access for ambient IoT device.

To address these issues, the ambient IoT device 112 may be configured to implement random resource allocation functions that may mitigate collisions with nearby ambient IoT devices and improve the overall performance of the wireless network 100. In some embodiments, the ambient IoT device 112 may include circuitry, programing, or a combination thereof for implementing the capabilities and/or functions related to random resource allocation, as disclosed herein. In some embodiments, the intermediate node 142 may include circuitry, programing, or a combination for implementing the capabilities and/or functions related to random resource allocation, as disclosed herein.

For example, FIG. 1 depicts that the intermediate node 142 may be configured with a random resource allocation circuit 140, which enables intermediate node 142 to execute the capabilities and/or functions for random resource allocation, as disclosed in greater detail herein; and ambient IoT device 12 may implement a random resource allocation circuit 150 which enables the ambient IoT device 112 to execute the capabilities and/or functions for random resource allocation, as disclosed in greater detail herein.

In some embodiments, the random resource allocation circuits 140, 150 may be configured to implement several capabilities and/or functions including, but not limited to: sensing-based functions for random resource selection, successive interference cancellation functions that may improve the reliability of the UL transmissions; intermittent sensing and pre-emption functions that implement channel reservation signals and intermittent sensing for pre-empting low priority devices; beamforming functions that implement sequential triggering of the ambient IoT devices (thus reducing the number of devices attempting to communicate simultaneously with the source); guided random resource selection functions that implement a signaling of future resource reservations by ambient IoT devices to reduce collisions; and reduced signaling and association functions that may reduce collisions by introducing an association between resources.

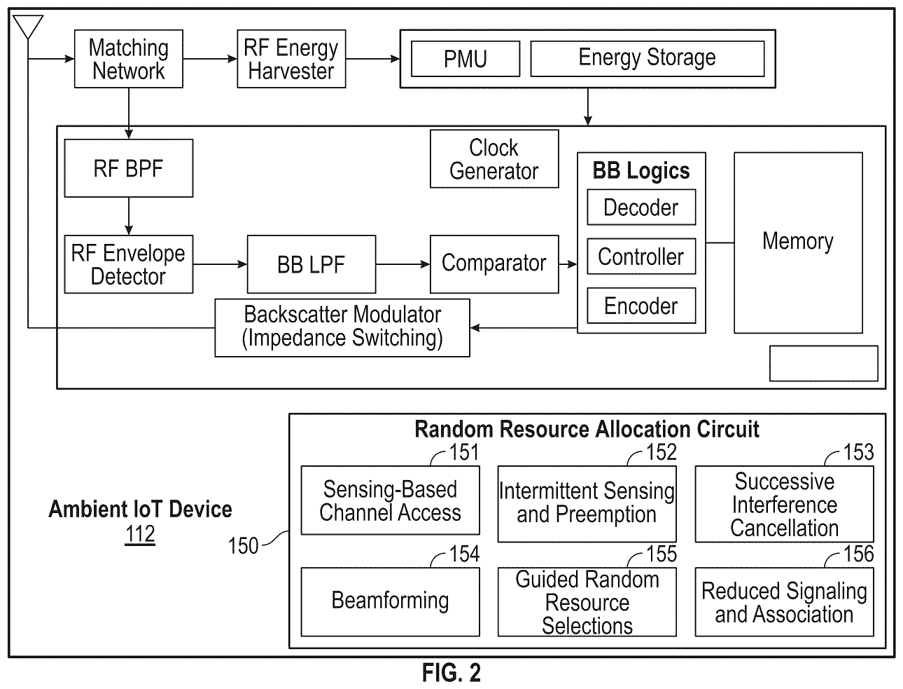

FIG. 2 is a block diagram depicting an example ambient IoT device 112 implementing a random resource allocation circuit 150 for supporting random resource allocation and/or selection functions, according to some embodiments of the present disclosure.

As illustrated in FIG. 2, an example configuration of the ambient IoT 112 (e.g., see FIG. 1) can include multiple hardware and/or software components implementing capabilities of an ambient IoT device, including energy storage, backscattering transmission, and/or the like. Each of the hardware and/or software components in the example configuration for the ambient IoT 112 are not described in detail herein for brevity, and can operate in accordance with some wireless communication technology standards without departing from the scope of the invention. Additionally, the example configuration of the ambient IoT 112 is not intended to be limiting to the embodiments disclosed herein, and hardware and/or software components may (or may not) be implemented in the architecture as deemed optimal and/or suitable.

FIG. 2 depicts an example configuration of the ambient IoT 112 (e.g., see FIG. 1) that can include multiple hardware and/or software components implementing capabilities related to random resource allocation functions. The ambient IoT device 112 depicted in FIG. 2 is not intended to be limiting, and the related structure and/or functions of the components may be implemented in a wide variety of configurations, without departing from the scope of this disclosure. In some embodiments, the ambient IoT device 112 may be configured to implement the functions related to random resource allocation that are performed on the UE side, as disclosed herein.

Additionally, in some embodiments, a source (e.g., intermediate node 142 shown in FIG. 1) may be configured with similar hardware and/or software components to implement the capabilities related to random resource allocation and/or selection, as described in reference to FIG. 2. In some embodiments, the source may be configured to implement the functions related to random resource allocation that are performed on the network side, as disclosed herein. In some embodiments, the ambient IoT device 112 including the random resource allocation circuit 150 may be configured to implement functions in addition to and/or in lieu of the functions of the source (e.g., network side) without departing from the scope of the disclose embodiments.

In some embodiments, the ambient IoT device 112 may include a random resource allocation circuit 150 that may be configured to implement random resource selection and/or allocation, as disclosed herein, realizing reduced collisions between the transmissions (e.g., UL transmission) of ambient IoT devices (e.g., proximately located ambient IoT devices and/or neighboring IoT devices). In the example of FIG. 2, the random resource allocation circuit 150 may be configured to include circuitry executing the disclosed random resource allocation functions and procedures, the circuitry including: sensing-based channel access circuitry 151; intermittent-sensing and pre-emption circuitry 152; successive interference cancellation circuitry 153; beamforming circuitry 154; guided random resource selection circuitry 155; and reduced signaling and association circuitry 156.

The sensing-based channel access circuitry 151 may be configured to implement a channel sensing based random resource selection for ambient IoT devices.

In some ambient IoT systems, a large number of devices may attempt to communicate with the source, which can be referred to as UL transmissions from the ambient IoT devices to the source. The UL transmissions from the ambient IoT devices may originate within the ambient IoT device, or may be based on backscattering of a DL energizing signal. A random access approach may be utilized in some wireless communication technology standards (e.g., 3GPP NR) to improve the resource utilization and/or increase the number of simultaneously supported ambient IoT devices (e.g., similarly to 3GPP NR sidelink transmissions). For example, a random resource selection approach may be utilized, where devices randomly select the resources for transmission under certain constraints (e.g., the measured channel occupancy should be below a threshold before a low priority UE can perform its random resource selection for a sidelink transmission). Similarly, the ambient IoT device 112 may have the capability to perform energy detection on one or more carrier frequencies and accordingly obtain a channel busy ratio (CBR) measurement parameter. In some embodiments, the CBR parameter can refer to a number of channel/slot resources with a measured reference signal received power (RSRP) that may be above a set (or defined) threshold, in relation (e.g., ratio) to a total number of channel/slot resources within a set (or defined) duration (see e.g., FIG. 3). In some embodiments, the CBR parameter may refer to a duration for which the channel is measured as occupied, in relation to a measurement window (e.g., irrespective of the underlying number of slots). In some embodiments, the CBR parameter may refer to a ratio of channels with energy detected over a total number of available channels, where a channel can be considered as occupied if an energy is detected at any slot within the measurement window. There may be issues associated with utilizing the limited power resources of an ambient IoT 112 for measuring the CBR parameter. Accordingly, in some embodiments, the sensing-based channel access circuitry 151 may be configured to enable the ambient IoT 112 to measure the CBR (e.g., consume power) when an energizing signal is present.

FIG. 3 depicts an example of random resource allocation for an ambient IoT device based on channel-based measurements. For example, FIG. 3 illustrates a CBR measurement window 330 that may be triggered by an energizing signal 311 (e.g., through a specific overlaid sequence). The CBR measurement window 330 can span multiple time slots, including a first time slot 321 (e.g., time slot M), time slot 322 (e.g., time slot M+1), and time slot 323 (e.g., M2). During the CBR measurement window 330, UL signal 312 and UL signal 314 may be transmitted time slot 322 (e.g., time slot M+1). An UL signal 313 may be transmitted at time slot 323 (e.g., M2). The CBR measurements may be performed by the ambient IoT devices to control the number of random access transmissions within the CBR measurement window 330 and while the energizing signal 311 is being transmitted. In some embodiments, the CBR measurements can be performed by a source then conveyed to the devices, in manner that may reduce consumption of the limited resources that may be associated with ambient IoT devices.

In the case where the sensing-based channel access circuitry 151 measures the CBR on resources where the energizing signal is present, the circuitry 151 may utilize a set (or defined) time interval in which the CBR may be measured. If, on some resources, the energizing signal is not present, the sensing-based channel access circuitry 151 may omit those resources (e.g., with respect to measuring the CBR). In some embodiments, the sensing-based channel access circuitry 151 may measure the CBR for a set duration of time, where the sensing-based channel access circuitry 151 may track the time (e.g., time elapsed within the duration). The sensing-based channel access circuitry 151 may be configured to omit resources where the energizing signal is not present but may override to measure the CBR for a specified duration if deemed suitable and/or necessary.

The sensing-based channel access circuitry 151 may be configured to then utilize the CBR measurement to determine whether to access the system or refrain from transmitting. For instance, if the sensing-based channel access circuitry 151 determines that the measured CBR is below a set (e.g., pre-configured) priority-based threshold, the sensing-based channel access circuitry 151 may enable the ambient IoT device 112 to perform the random-access procedure and accordingly perform the transmission. Alternatively, if the sensing-based channel access circuitry 151 determines that the measured CBR is above the set threshold, the sensing-based channel access circuitry 151 may control the ambient IoT device 112 to prevent the transmission (e.g., disable transmission).

In some embodiments, the sensing-based channel access circuitry 151 may be configured to utilize the measured CBR to control a set (e.g., pre-defined) number of allowed transmissions within a given duration. For instance, if the sensing-based channel access circuitry 151 determines that the measured CBR at a slot (e.g., slot N) is above the set threshold for a transmission priority (e.g., priority p), then the sensing-based channel access circuitry 151 may enable the ambient IoT device 112 to perform a set number of transmission.

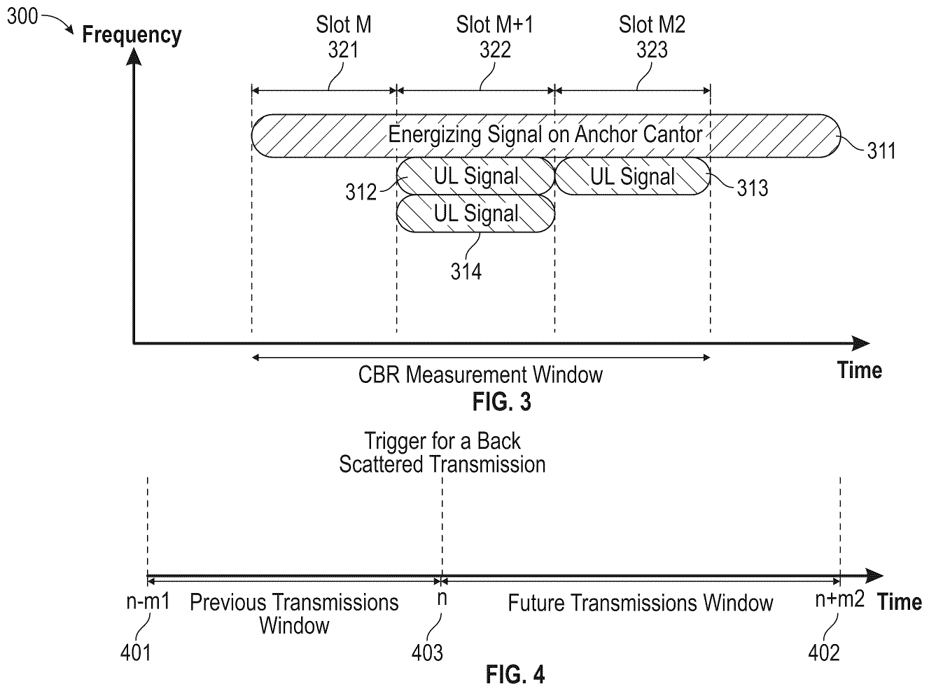

FIG. 4 depicts an example of a timing of transmissions for the ambient IoT device 112 that may be implemented by the sensing-based channel access circuitry 151, based on the measured CBR. FIG. 4 illustrates that the sensing-based channel access circuitry 151 may be configured to enable the ambient IoT device 112 to perform a set number (x) of transmissions within two time windows that may be defined with respect to a time instant 403 (e.g., n) when the ambient IoT device 112 may be triggered for a back-scattered transmission (e.g., n), shown as time window 401 (e.g., n-m₁) and time window 402 (e.g., n+m₂, where n-m₁ includes previous transmissions before slot n and n+m₂ controls the number of intended future transmissions). In some embodiments, the windows 401, 402 may be defied to also include an offset in order to account for processing at the ambient IoT device 112. In some embodiments, values used for the CBR parameter may be set (pre-defined) for the sensing-based channel access circuitry 151, for example if the CBR measurements are not available and/or are not sufficient (e.g., not enough duration has been measured). The set CBR parameter and associated values may be dependent on the transmission priority, in some embodiments.

In some cases, the sensing-based channel access circuitry 151 may be configured to utilize the CBR measurement to control a transmit power of the ambient IoT device 112. For example, the sensing-based channel access circuitry 151 may be configured to reduce the transmit power of the ambient IoT device 112 (e.g., no amplification is allowed) if the sensing-based channel access circuitry 151 determines that the measured CBR is above a set threshold. In some embodiments, the sensing-based channel access circuitry 151 may be configured to define and/or utilize a threshold related to transmit power that may be priority based. For example, sensing-based channel access circuitry 151 may be configured to enable a transmission that is determined to be a higher priority to perform power amplification, if the sensing-based channel access circuitry 151 determines that the measured CBR is substantially high (e.g., above the defined threshold).

In some embodiments, the sensing-based channel access circuitry 151 may be triggered to execute CBR measurements for the ambient IoT device 112, for example by using a field (e.g., a one-bit field) in the control signaling or a medium access control (MAC) control element (CE). In some embodiments, the sensing-based channel access circuitry 151 may be passively enabled to execute CBR measurements for the ambient IoT device 112, for example receiving an energizing signal on a configured carrier (e.g., from the gNB) or by receiving a certain pattern for the energizing signal (for example an on-off signaling pattern). In addition, the CBR measurements may also be set (e.g., pre-configured) per resource pool to be performed when the energizing signal is present and the ambient IoT device 112 is in the receiving mode (i.e., not triggered to perform a transmission). In this case, the source (e.g., gNB) may send a longer energizing signal to allow the ambient IoT device 112 to perform the CBR measurements before performing the transmission(s).

In some embodiments, the sensing-based channel access circuitry 151 may be configured to confine performing CBR measurements to the carriers over which back scattering is allowed, based on resource pool configuration, and/or performing CBR measurements on all the carriers that can be used by the ambient IoT device 112 for transmission(s). In some embodiments, sensing-based channel access circuitry 151 may limit CBR measurements to a subset of the carriers that can potentially be used by the ambient IoT device 112 for back scattering. Additionally, in some embodiments, the sensing-based channel access circuitry 151 may be configured to receive and/or utilize CBR measurements that are performed by a source. For example, the source (e.g., intermediate node, UE, etc.) can perform energy measurements to obtain the CBR measurements, and then forward this measurement as a parameter to nearby ambient IoT devices (e.g., in a DL control signaling). Because the ambient IoT device 112 and the source may be positioned at different physical locations, there may be cases in which performing the CBR measurements at the IoT device-side may be deemed optimal and/or suitable (e.g., increased accuracy of CBR measurements). In contrast, there may be cases in which performing the CBR measurements at the source-side may be deemed optimal and/or suitable (e.g., significantly reduce the sensing burden on the ambient IoT device 112). In addition, to mitigate some drawbacks that may be associated with performing CBR measurements, a larger sensing range can be considered by the source to be able to detect the occupancy by ambient IoT devices that are far from the source. For example, a configured (e.g., pre-defined) offset on the resource occupancy threshold levels may be applied when the CBR measurements are performed by the source (e.g., intermediate node, and/or UE). In some embodiments, the resource occupancy thresholds may be lowered when the source is performing the CBR measurements on behalf of the ambient IoT device 112.

In some embodiments, the intermittent-sensing and pre-emption circuitry 152 may be configured to implement multi-slot transmission that combines multiple transmissions, and thereby may further reduce the chances of collisions between proximately located ambient IoT devices. For example, the intermittent-sensing and pre-emption circuitry 152 may trigger a timer before performing a transmission such that if multiple transmissions are triggered within this timer (e.g., multiple transport blocks (TBs) or repetitions of the same TB), one random access may be performed to acquire the resources. In the case of sending multiple TB retransmissions and/or multiple independent TBs, this can be done simultaneously on different carriers, and/or subsequently on the same carrier, and/or any combination thereof. For example, if the ambient IoT device 112 receives two energizing carriers, the device 112 may perform the up/down conversion on both carriers and accordingly perform the backscattered transmission on two carriers simultaneously (e.g., each carrying one TB transmission). Alternatively, the ambient IoT device 112 may perform the two transmissions sequentially in time, in some embodiments.

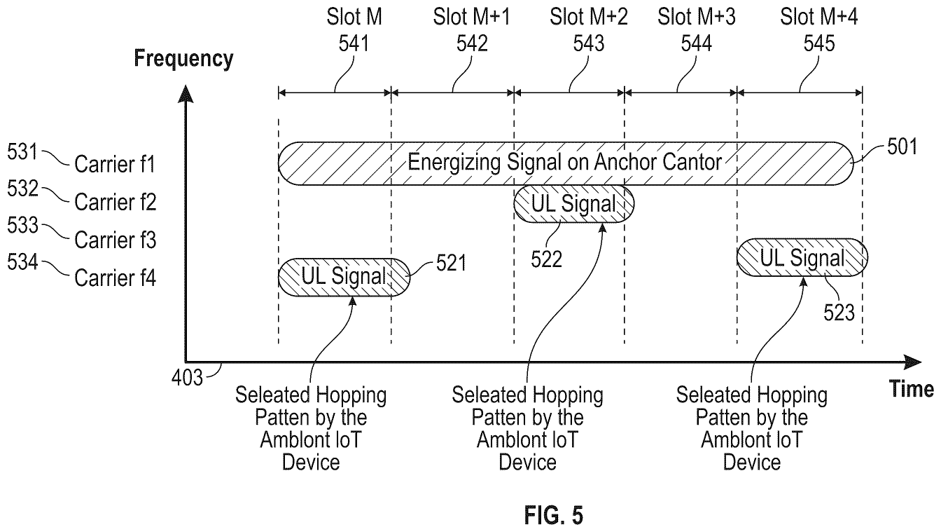

In some embodiments, the intermittent-sensing and pre-emption circuitry 152 may be configured to implement carrier hopping (or slot hopping), to reduce the chances of consistent collisions between proximately located ambient IoT device (that selected to perform a transmission on the same carrier at the same starting time slot). For example, the intermittent-sensing and pre-emption circuitry 152 may execute carrier hopping in which the ambient IoT device 112 switches, or “hops” across, to a different carrier frequency (for each TB and/or TB retransmission). The intermittent-sensing and pre-emption circuitry 152 may randomly select a sequence of carriers to perform transmission for the ambient IoT 112, where in each transmission instance a certain carrier frequency is used. FIG. 5 depicts an example of timing for transmissions for an ambient IoT device 112 based on carrier hopping that may be implemented by the intermittent-sensing and pre-emption circuitry 152.

FIG. 5 illustrates that an energizing signal 510 may be transmitted across multiple time slots 541-544. While the energizing signal 510 is being transmitted, the ambient IoT device may be triggered to perform UL transmissions 521-523 in accordance with a selected hopping pattern. An UL transmission 521 may be performed at slot 541 (e.g., slot M) and at a carrier frequency 534 (e.g., carrier frequency f₄). Another UL transmission 522 that may be performed at a later time slot 543 (e.g., slot M+2), and the transmission may “hop” to a different carrier frequency 532 (e.g., carrier frequency f₂) than the resource used for the previous UL transmission 521. Another subsequent UL transmission 523 may be performed by the ambient IoT device at a later time slot 545 (e.g., slot M+4), and may “hop” to a another carrier frequency 533 (e.g., carrier frequency f₃) that is different from the resources that were utilized for the previous UL transmission 521 and UL transmission 522. In the example of FIG. 5, the “hops” are shown to be separated in time by one slot, but the disclosed embodiments are not limited thereto (e.g., hops may be contiguous in time).

In some embodiments, the intermittent-sensing and pre-emption circuitry 152 may be configured to select the sequence of carriers based on a standardized procedure and/or by randomly selecting a sequence from a configured (e.g., pre-configured) set. In some embodiments, the intermittent-sensing and pre-emption circuitry 152 may be configured to utilize intermittent on-off and/or sensing. For example, intermittent-sensing and pre-emption circuitry 152 may determine to perform the first transmission for the ambient IoT device 112 in the TB at a slot (N) that lasts for a set number (X) of slots. Subsequently, the intermittent-sensing and pre-emption circuitry 152 can include an intermittent channel occupancy reservation duration, when energy is transmitted (e.g., without data being transmitted) to maintain the channel. This channel occupancy reservation signal may last for a duration that is randomly selected from a configured window, and/or the channel occupancy reservation signal can be based on a set window, and/or the channel occupancy reservation signal may be based on a set (e.g., pre-defined) transmission priority (e.g., high priority transmission can reserve the channel for longer or shorter durations). The slots over which the channel occupancy reservation signal is sent can also be randomly selected and/or the slots may be set (e.g., pre-configured) per resource pool (e.g., every fourth slot).

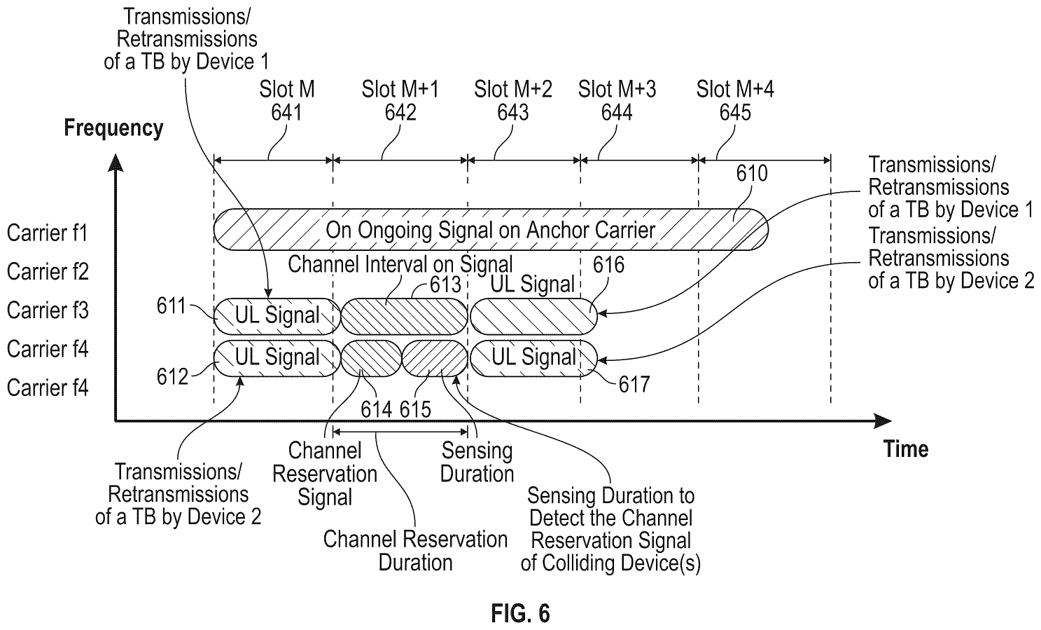

During the channel reservation duration, the intermittent-sensing and pre-emption circuitry 152 can stop the transmission one or more times for the ambient IoT device 112 and perform sensing or energy detection. The slots at which the transmission of the energizing signal is interrupted can be randomly selected and/or the slots can be set (e.g., pre-configured) per resource pool, and/or the slots can be dependent on a defined priority. In addition, the number of interruptions can be randomly selected, and/or set (e.g., pre-configured) based on a priority. For example, if it is determined that the ambient IoT device is a low priority device, the intermittent-sensing and pre-emption circuitry 152 may be configured to interrupt its transmission multiple times (e.g., two times). In a case where a transmission from the ambient IoT device 112 may be deemed high priority, the intermittent-sensing and pre-emption circuitry 152 may contiguously send the channel occupancy signal without interruptions. During each interruption duration, the intermittent-sensing and pre-emption circuitry 152 may perform energy detection and if the channel is identified as occupied (e.g., its detected energy is above a configured threshold), the intermittent-sensing and pre-emption circuitry 152 may refrain from performing transmission and/or switch to a different channel (e.g., for subsequent repetition of the TB). For instance, by implementing the disclosed slot hopping mechanism, the intermittent-sensing and pre-emption circuitry 152 may be able to mitigate (and/or reduce) collisions in a case where two or more ambient IoT devices transmit on the same channel, where the devices may otherwise experience consistent collisions between TB repetitions. To allow the combining of multiple repetitions of the same TB, the intermittent-sensing and pre-emption circuitry 152 may include in its control signaling the location of the previous repetition of the TB such that the TBs can be combined at the source. FIG. 6 depicts an example of timing for transmissions based on intermittent sensing and pre-emption for multi-slot transmissions that may be implemented by the intermittent-sensing and pre-emption circuitry 152 to reduce collisions (e.g., between proximately located ambient IoT devices).

FIG. 6 illustrates that an energizing signal 610 may be transmitted across multiple time slots 641-644. While the energizing signal 610 is being transmitted, ambient IoT devices may be triggered to perform UL transmissions 611, 612, 616, and 617 in accordance with intermittent sensing. For example, ambient IoT devices may select a set of consecutive resources for their TB transmissions/retransmissions. In the example of FIG. 6, the transmission/retransmission of a TB for a first ambient IoT device may be performed as the UL transmission 611 at a time slot 641 (e.g., slot M) and UL transmission 616 at a time slot 643 (e.g., slot M+2). The transmission/retransmission of a TB for a second ambient IoT device may be performed as the UL transmission 612 at a time slot 641 (e.g., slot M) and UL transmission 617 at the time slot 643 (e.g., slot M+2).

Between the consecutive UL transmissions 611, 612, 616, and 617, an energy signal may be transmitted to maintain the channel occupancy. A channel reservation signal 613 may be transmitted by the first ambient IoT device, having a duration that spans the entire time slot 642 (e.g., slot M+1). The second ambient IoT device may transmit a channel reservation signal 614 and a sensing duration 615 within the time slot 642 (e.g., slot M+1). The signal duration 615 may be utilized to detect the channel reservation signal 613 transmitted by the first ambient IoT device that may potentially cause a collision. The duration of the energy signal is dependent on the device priority. For example, the second ambient IoT device may be a low priority device that is configured to switch to energy detection to identify the presence of possible a high priority device, for example the first ambient IoT device, with a longer channel occupancy signal.

In some embodiments, the sensing-based channel access circuitry 151 may be configured to implement a pre-emption of transmissions for ambient IoT device 112. For example, if the ambient IoT device 112 is deemed as a higher priority, when the sensing-based channel access circuitry 151 detects the channel as occupied, a channel reservation signal may be transmitted at one or more slots. These slots can be selected based on a set (e.g., pre-configured) timing (e.g., every fourth slots starting from slot 0), and/or slots can be randomly selected by the sensing-based channel access circuitry 151 and last for a given duration (e.g., four consecutive slots starting from a randomly selected slot). The duration may be randomly selected by the sensing-based channel access circuitry 151, and/or the duration can be based on a set (e.g., pre-configured) timing, and/or the duration may be based on priority. For example, in a case where low priority ambient IoT devices are configured to perform only two consecutive slot transmissions before performing sensing, then the sensing-based channel access circuitry 151 may select a duration as three slots to ensure that the ambient IoT 112 (when deemed as a low priority device) can detect the reservation signal (e.g., send by a high priority IoT ambient devices). As a general description, the lower priority IoT ambient devices may detect a reservation signal by the higher ambient IoT devices and will be pre-empted and the resources of the low priority devices may be revoked to be more optimally used by the high priority transmissions and/or higher priority devices.

In some embodiments, the sensing-based channel access circuitry 151 may be configured to implement a pre-emption that can be restricted to a subset of the resources (e.g., resources that are accessible only by low priority transmissions). For example, a resource pool can be configured with a subset of the carriers that can be used for pre-emption by high priority ambient IoT devices, but otherwise may be used by low priority ambient IoT devices. A high priority ambient IoT device may identify the priority of the ongoing ambient IoT transmission, and pre-emption may be triggered if the identified priority is below set threshold. The pre-emption mechanism may be supported by detecting the control portion of the scheduling signal from the source and/or the control portion transmitted by a nearby ambient IoT device. The pre-emption procedure implemented by the sensing-based channel access circuitry 151 may be enabled and/or disabled based on system configurations (e.g., resource pool configuration).

In some embodiments, the sensing-based channel access circuitry 151 may be configured to implement a mixed resource selection procedure of transmissions for ambient IoT device 112. For example, if a resource pool is used by the ambient IoT device 112, the scheduling approach utilized may differ for different device types. For example, an ambient IoT of a first type (e.g., Type-C) may be scheduled by the source (e.g., transmission at a point in the future), and ambient IoT devices of a second type (e.g., Type-A) and a third type (e.g., Type-B) may utilize random resource selection to select the resource for UL transmissions. The type (e.g., Type-C) of ambient IoT device may be associated with having its own energy source, and thus may utilized a scheduled resource. Types (e.g., Type-A and Type-B) of ambient IoT devices may be associated with utilizing back scattering, and thus resources for the transmission may be confined within a time limit (during which the energizing signal is present). The time duration can be either set (e.g., pre-configured) per resource pool and known to the ambient IoT device (e.g., X number of slots), and/or the time duration can be dynamic selected and indicated to the ambient IoT device (e.g., through DL control signaling). In the case of a set time duration, different device types and/or priorities may be set (e.g., pre-configured) with different values to reduce collisions between these device types. For instance, a “Type-A” ambient IoT device may be configured with a set time limit duration (e.g., five slots), and a “Type-B” ambient IoT device may be configured with a different set time duration that may be relatively lager (e.g., eight slots). In this case, the last slots (e.g., 3 slots) of the potential random-access duration will be accessible by the “Type-B” ambient IoT device, thus reducing potential collisions between the devices.

In some embodiments, the sensing-based channel access circuitry 151 may be configured to implement a mixed resource selection procedure based on priority. For example, the higher the priority of the device, the longer its configured duration for random resource selection may be set. In case of dynamic allocation of resources for “Type-A” ambient IoT devices and/or “Type-B” ambient IoT devices, the duration may be dependent on the resources that are available for UL transmission. For example, a source (e.g., UE) may perform sensing, and accordingly reserve a set number of future resources to be used by ambient IoT devices for UL transmissions. Subsequently, the source may indicate (e.g., in a DL control signaling) the number of available resources during which the energizing signal will be present and the ambient IoT devices can perform their transmissions. In some embodiments, the UE may be scheduled by the gNB, where the gNB can include in its downlink control information (DCI), the resources that are scheduled to the UE to receive the UL transmissions. These resources may then be forwarded to the ambient IoT devices (in the DL control signaling) to be able to identify the resources that can be randomly selected for UL transmissions. With respect to “Type-C” ambient IoT devices, the scheduled resources for “Type-C” ambient IoT devices may be excluded from the duration, for example when signaling the resources available for random resource selection, in order to reduce collisions.

In some embodiments, to signal the duration in the DL control signaling, a starting point and a duration may be utilized. In this case, the DL control signaling may include the starting offset of the first slot from the current slot, and the duration for which the time limit duration is active. In some embodiments, to signal the duration in the DL control signaling, a duration is utilized. In this case, the starting offset can be set (e.g., pre-configured) (e.g., one slot to allow for processing delay). In some embodiments, to signal the duration in the DL control signaling, an index from a set is utilized. The index may be used to select a starting slot offset and/or a duration from a configured set.

The successive interference cancellation circuitry 153 may be configured to implement interference reduction through successive interference cancellation (e.g., at the source). As described herein, performing resource selection may include the ambient IoT device 112 executing random selections to avoid collisions with other nearby IoT devices. However, often in IoT systems, a large number of ambient IoT devices may be present in the same wireless communication environment and triggered (for utilizing resources) at any given instance, thus there may still be a likelihood that collisions will occur between the transmissions of proximately located ambient IoT devices utilizing resource selection according to some wireless communication technology standards. To address these and other issues, the successive interference cancellation circuitry 153 may execute sending multiple repetitions of the same TB in different time slots and/or carriers. The successive interference cancellation circuitry 153 may be configured to determine the number of allowed TB retransmissions based on various factors. For example, the successive interference cancellation circuitry 153 may be configured to utilize multiple UL TB repetitions to improve the reliability of an UL transmission, where the selected number of repetitions may be based on one or more factor, including, but not limited to: transmission priority; channel occupancy; number of previous transmissions; measured signal strength; the number of successfully received transmissions in the DL; direct indication from the source; and/or the like.

Successive interference cancellation processes (e.g., multiple UL TB repetitions) that are based on priority may involve configuring higher priority ambient IoT devices with a set number of repetitions per device which is relatively high (e.g., larger that a number of repetitions utilized for lower priority ambient IoT devices). Successive interference cancellation processes based on channel occupancy, may involve utilizing a lower number of repetitions as the channel occupancy becomes higher, which may avoid flooding an occupied channel with a large number of transmissions. Successive interference cancellation processes based on a number of previous transmissions may involve associating an ambient IoT device category and/or type (e.g., X type of ambient IoT device) with a certain number of transmissions (e.g., Y number of transmissions) within a time window. The values that are utilized or related parameters, such as device type (e.g., X), number of transmissions (e.g., Y), can be set per resource pool, in some embodiments.

Successive interference cancellation processes based on the received signal strength, may involve performing channel measurements on the reference signals (e.g., embedded within the DL transmissions, or on the received energizing signal). Subsequently, the channel quality may be identified, and accordingly the number of repetitions to use in the UL may be selected based on the measured signal strength.

Successive interference cancellation processes based on the number of successfully received transmissions (e.g., in the DL transmission) may involve utilizing a ratio related to the successfully received transmissions at the ambient IoT device 112 to control the number of UL transmissions. For example, if the source sends multiple repetitions of the DL transmissions, then a ratio of the correctly received transmissions to the total number of transmissions may be determined and then used to control the number of UL transmissions. A window may be established in which the successive interference cancellation circuitry 153 can identify the number of successfully received DL transmissions from the source. The number of successfully received DL transmissions can then be divided by the total number of repetitions, which then calculates the success ratio. The successive interference cancellation circuitry 153 may then decide on the channel quality and select the number of repetitions to utilize in the upcoming UL transmissions (e.g., assuming DL/UL reciprocity). The number of repetitions determined by the successive interference cancellation circuitry 153 can be based on several factors, including the ambient IoT device implementation, a defined (e.g., pre-configured) number of repetitions; and/or the like.

Successive interference cancellation processes based on direct indication from the source may involve the source indicating the number of allowed transmissions (e.g., UL transmission). The number of allowed transmissions may be selected for specified devices (e.g., by using the ambient IoT device ID), and/or selected for a subset of ambient IoT devices (e.g., by using a groupcast ID). In some embodiments, number of allowed transmissions may be selected based on the device type, and/or a device priority. For example, an ambient IoT device with a high priority may be allowed to perform multiple UL transmissions, and ambient IoT devices with a low priority may be allowed to perform a lower and/or limited number of UL transmission per TB (e.g., a single transmission).

In some embodiments, the successive interference cancellation circuitry 153 may implement successive interference cancellation to improve the overall system performance related to employing TB repetition mechanisms for resource allocation, as previously described. For example, successive interference cancellation may improve performance of the repetition-based processes in scenarios where the system is highly occupied (e.g., the system occupancy is above 30%) and thus the likelihood of collisions may be relatively high between the TB retransmissions. Some ambient IoT devices may be utilized in a wireless communication environment that is indoors, and the devices may be mostly stationary which may lend itself to substantially larger channel coherence time. For example, TB transmissions sent in consecutive slots, in such a wireless communication environment (e.g., indoors, stations, etc.), may experience the same channel conditions and a channel delay spread that may be substantially low, thus rendering the channel coherence bandwidth to be large. Additionally, adjacent carriers may experience the same channel conditions, in some wireless communication environments for ambient IoT devices. Therefore, in some embodiments, successive interference cancellation may be implemented at the source on the received messages from the ambient IoT devices in order to further reduce the incurred interference level and improve the system performance.

In some embodiments, a random resource selection phase may be implemented, where the ambient IoT device 112 may randomly select time/frequency resources for their UL transmission. For example, the device 112 may intend to perform a set number (e.g., X) of transmissions of the same TB, and thus can select the slots and/or subcarriers to be used for each transmission. Although the device 112 may send multiple repetitions of the same TB within a slot (using different carriers), the repetitions may be limited to the case where multiple energizing signals can be received in order not to further reduce the transmit power in the UL. This may be the case, when the ambient IoT device 112 utilizes backscattering for UL transmissions (e.g., without power amplification). The ambient IoT device 112 may select different carriers in different slots for the TB retransmissions. The ambient IoT device 112 may also select a sequence of transmissions (rather than a single transmission). For example, a set of defined (e.g., pre-configured) sequences of resources may be provided to the ambient IoT device 112 for resource selection. Subsequently, the ambient IoT device 112 may randomly select the sequence and accordingly use the resources within the selected sequence for the TB transmissions and retransmissions. A sequence can be represented by a (slot X, carrier frequency f). For example, a sequence represented as {(X,f₁), (Y, f₂)} may indicate that the first transmission of the TB may occurs in slot X on carrier f₁, and the retransmission of the TB may occur in slot Y on carrier f₂.

Additionally, in some embodiments, a signaling phase may be implemented. The signaling phase may involve, in each of the UL transmissions performed by the ambient IoT device 112, indicating the locations of the remaining TB retransmissions (and their number if not pre-configured or already known by the source) in the transmitted instance of the TB. For example, the ambient IoT device 112 may elect to transmit the TB and retransmission at slots X and Y, on carriers f₁ and f₃, respectively. In this case, in the first transmission of TB, the ambient IoT device 112 may indicate that the next retransmissions can be sent in slot Y on carrier f₃. Similarly, when performing the second transmission, the ambient IoT device 112 may indicate that the first instance of the transmission is sent in slot X and on carrier f₁. This information can be indicated in the control signaling (e.g., through one or more TRIV/FRIV fields), and/or indicated utilizing a sequence of transmissions (e.g., by indicating a sequence index from a configured set), and indicating the location within the current sequence. For example, the ambient IoT device 112 may indicate the index of the sequence {(X, f₁), (Y, f₂)}, and then indicate that the current transmission is the first transmission of the TB. In addition, the locations of the transmission and/or the retransmission may be indicated relatively to reduce the signaling overhead. For instance, instead of signaling that the next retransmission may be on slot Y, the signal may include the difference in slots between slots Y and X. Similarly, the ambient IoT device 112 may indicate the difference between the current carrier and the future and/or past carrier. In some embodiment, the signaling phase may involve the ambient IoT device 112 indicating the time slot and the carrier of the previous transmission(s).

Successive interference cancellation phase may be implemented. The successive interference cancellation phase done by the source (e.g., the gNB or the UE), but the embodiments are not limited thereto. Accordingly, the successive interference cancellation circuitry 153 may be configured to implement one or more functions related to the successive interference cancellation aspects described herein, in addition to and/or in lieu of the functions performed by the source. The source may be able to detect a transmission of the TB, and then can identify the location of the remaining retransmissions of the TB. Subsequently, the source may decode (e.g., iteratively) the received signals in the time and/or frequency resources to resolve collisions.

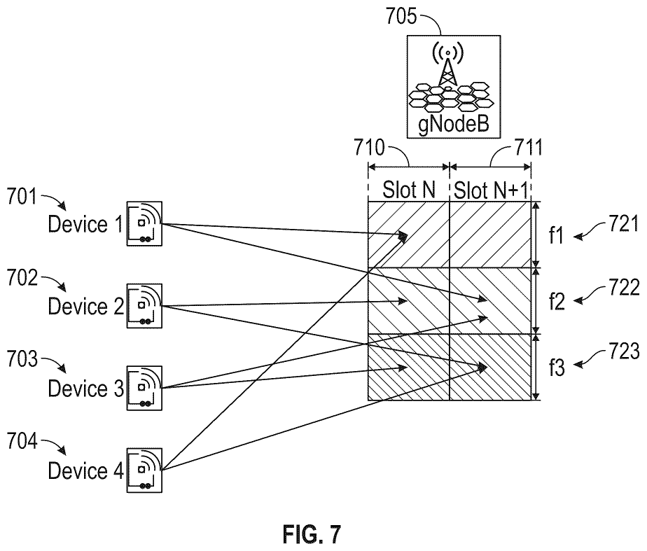

For example, as shown in FIG. 7, an example wireless communication environment may include multiple ambient IoT devices 701-704 that may be attempting to communicate with the gNB 705. Each of the ambient IoT devices 701-704 may be attempting to perform two transmissions per TB. The gNB 705 (e.g., the receiver) can first attempt to decode the received transmissions at resources including carrier frequency f₁ 721, carrier frequency f₂ 722, and carrier frequency f₃ 733 at slot N 710. In this case, ambient IoT device 702 and ambient IoT device 703 may be detected. However, FIG. 7 illustrates that the attempted transmission of ambient IoT device 701 and ambient IoT device 704 may collide.

Subsequently, the gNB 705 may become aware that a second repetition of ambient IoT device 702 and ambient IoT device 703 may occur in slot (N+1) 711 on carrier frequency f₃ 721 and carrier frequency f₂ 722, respectively. After receiving in Slot (N+1) 711, the gNB 705 may be configured to then apply successive interference cancellation to remove the effect of the retransmissions of ambient IoT device 702 and ambient IoT device 703 in slot (N+1) 711. This may allow the gNB 705 to decode the transmissions from ambient IoT device 701 and ambient IoT device 704 that may be transmitted in slots (N+1) 711 on carrier frequency f₂ 722 and carrier frequency f₃ 723, respectively. Without successive interference cancellation mechanisms, as described herein, the gNB 705 would not have been able to receive the transmissions from ambient IoT device 701 and ambient IoT device 704 because of the collisions with the retransmissions of ambient IoT device 702 and ambient IoT device 703. In some embodiments, successive interference cancellation may involve allowing each ambient IoT devices 701-704 to signal to the gNB 705 (e.g., source) the future and/or past retransmissions of the current TB such that an impact that interference from these retransmissions may have on the other ambient IoT devices may be mitigated and/or reduced.

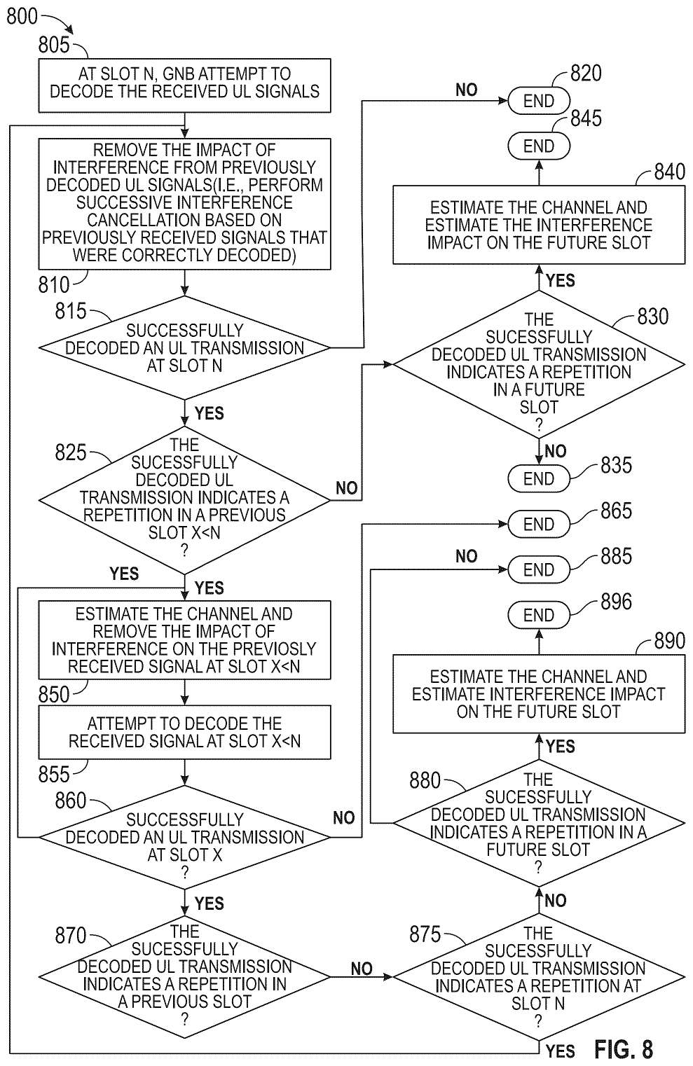

FIG. 8 depicts a flow chart for a method 800 implementing successive interference cancellation at the gNB (e.g., source), as disclosed herein. For example, the gNB 705 (see e.g., FIG. 7) may be configured to implement the method 800.

At operation 805, the gNB may attempt to decode the received UL signals. For example, multiple ambient IoT devices may perform multiple repetitions when sending TB transmissions. The repetitions may be sent on randomly selected time and/or frequency resources. Each repetition includes an indication (e.g., time/frequency offsets) to point at the resources used to carry the remaining repetitions.

At operation 810, the gNB may perform successive interference cancellation, as disclosed herein. Once a TB is decoded successfully, the gNB may apply successive interference cancellation to resolve the collisions with the remaining device transmissions. The gNB may perform successive interference cancellation based on the previously received signals that were correctly decoded.

At operation 815, a conditional check may be performed to determine if the UL transmission was successfully decoded by the gNB at a slot (e.g., slot N). In the case when it is determined in operation 815 that the UL transmission was not successfully decoded (e.g., “No” in FIG. 8), then the method 800 may continue to operation 820 and the method 800 may end. Alternatively, in the case when it is determined at operation 815 that the UL transmission was not successfully decoded (e.g., “Yes” in FIG. 8), then the method 800 may continue to operation 825.

At operation 825, a conditional check may be performed to determine if the successfully decoded UL transmission indicates a repetition in a previous slot. For example, an ambient IoT device may have transmitted a repetition of the TB in a previous slot (slot X) to the gNb, prior to the current slot (slot N). In the case when it is determined in operation 825 that the decoded UL transmission does not indicate that a repetition in a previous slot (e.g., “No” in FIG. 8), then the method 800 may proceed to operation 830 and performs another conditional check.

At operation 830, a conditional check may be performed to determine if the successfully decoded UL transmission indicates a repetition in a future slot. For example, an ambient IoT device may be scheduled to transmit a repetition of the TB in a subsequent slot that is after the current slot (slot N). In the case when it is determined in operation 830 that the decoded UL transmission does not indicate a repetition in a future slot (e.g., “No” in FIG. 8), then the method 800 may continue to operation 835 and the method 800 may end.

Alternatively, in the case when it is determined at operation 830 that the decoded UL transmission does indicate a repetition for a future slot (e.g., “Yes” in FIG. 8), then the method 800 may continue to operation 840.

At operation 840, the channel may be estimated for the future slot, and an interference impact may be estimated for the future slot. For example, the gNB may estimate the potential of a collision between transmissions of more than one ambient IoT device attempting to utilize the same future slot. Thereafter, the method 800 may continue to operation 845 and the method 800 may end.

Referring to operation 825, in the case when it is determined that the decoded UL transmission does indicate a repetition in a previous slot (e.g., “Yes” in FIG. 8), then the method 800 may proceed to operation 850.

At operation 850, the channel may be estimated, and successive interference cancellation may be performed. For example, the gNB may utilize successive interference cancellation to remove the impact of interference on the previously received signal (e.g., at slot X).

Thereafter, at operation 860, the gNb may attempt to decode the received signal at the previous slot (e.g., slot X).

At operation 865, a conditional check may be performed to determine if an UL transmission was successfully decoded at the previous slot (e.g., slot X). In the case where it is determined in operation 865 that an UL transmission was not successfully decoded at the previous slot (e.g., slot X) (“No” in FIG. 8), then the method 800 may proceed to operation 870 and may end. Alternatively, in the case where it is determined in operation 865 that an UL transmission was successfully decoded at the previous slot (e.g., slot X) (“Yes” in FIG. 8), then the method 800 may continue to operation 875.

At operation 870, a conditional check may be performed to determine if the successfully decoded UL transmission indicates a repetition in a previous slot. In the case where it is determined in operation 870 that the decoded UL transmission does indicate a repetition in the previous slot (“Yes” in FIG. 8), then the method 800 may return back to operation 825 and the subsequent operations may be iteratively performed. Alternatively, in the case where it is determined in operation 870 that the decoded UL transmission does not indicate a repetition in the previous slot (“No” in FIG. 8), then the method 800 may continue to operation 875.

At operation 875, a conditional check may be performed to determine if the successfully decoded UL transmission indicates a repetition at the current slot (e.g., slot N). In the case where it is determined in operation 875 that the decoded UL transmission does indicate a repetition in the slot (“Yes” in FIG. 8), then the method 800 may return back to operation 810 and the subsequent operations may be iteratively performed. Alternatively, in the case where it is determined in operation 875 that the decoded UL transmission does not indicate a repetition in the slot (“No” in FIG. 8), then the method 800 may continue to operation 880.

At operation 880, a conditional check may be performed to determine if the successfully decoded UL transmission indicates a repetition at a future slot. In the case where it is determined in operation 880 that the decoded UL transmission does not indicate a repetition in a future slot (“No” in FIG. 8), then the method 800 proceeds to operation 885 and the method 800 may end. Alternatively, in the case where it is determined in operation 880 that the decoded UL transmission does indicate a repetition in a future slot (“Yes” in FIG. 8), the method 800 continues to operation 890.

At operation 890, a channel to be utilized for a UL transmission in the future slot may be estimated. Operation 890 may also involve estimating an interference impact on the future slot. Thereafter, the method 800 can proceed to operation 895 and ends.

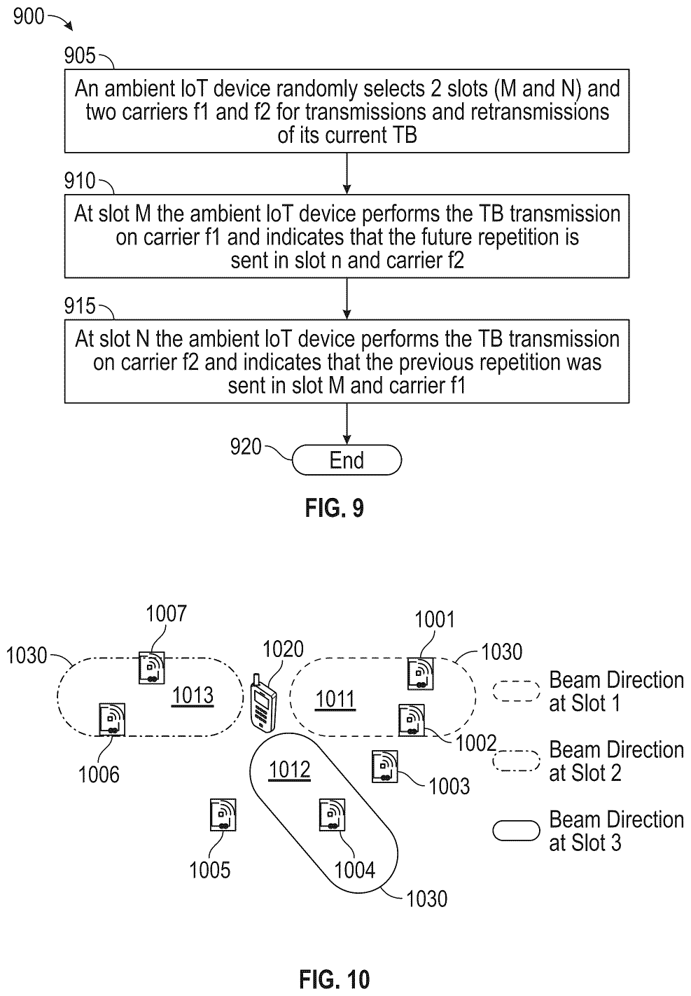

FIG. 9 depicts a flow chart for method 900 implementing successive interference cancellation at the ambient IoT device. For example, the successive interference cancellation circuitry 153 of an ambient IoT device 112 (see e.g., FIG. 2) may be configured to implement the method 900. For example, the method 900 may be executed when the successive interference cancellation is implemented involving two resources that are used for sending two repetitions of a TB.

At operation 905, an ambient IoT device may select resources for transmission and retransmissions of a current TB. For example, the ambient IoT device may randomly select two slots (e.g., slot M and slot N), and two carriers (e.g., carrier frequency f₁ and carrier frequency f₂) for transmission.

At operation 910, the ambient IoT device may perform the transmission of the TB at a current slot. Continuing with the example, the ambient IoT device may transmit in a first slot (e.g., slot M) using a first carrier (e.g., carrier frequency f₁), where the transmission may indicate that a future repetition may be sent at the second slot (e.g., slot N) utilizing the second frequency (e.g., carrier frequency f₂).

At operation 915, the ambient IoT may perform a retransmission of the TB (e.g., repetition) at the next slot. For example, the ambient IoT device may transmit in the second slot (e.g., slot N) using a second arrier (e.g., carrier frequency f₂). This transmission may indicate that the previous repetition was sent at the previous slot (e.g., slot M) utilizing the first frequency (e.g., carrier frequency f₁), enabling the source (e.g., gNB) that received the transmission signal to have the information to support successive interference cancellation. The method 900 may end at operation 920.

By implementing multiple repetitions and successive interference cancellation, as disclosed herein, the successive interference cancellation circuitry 153 may support random resource allocation mechanisms that can resolve collisions between ambient IoT device, thus improving the overall performance of a wireless communication system.

The beamforming circuitry 154 may be configured to implement controlled beamforming functions in a manner that may mitigate collisions between ambient IoT devices. For example, the beamforming circuitry 154 may perform a sequential triggering of the ambient IoT devices thus can reduce the number of devices attempting to communicate simultaneously with the source (e.g., gNB). For example, a subset of ambient IoT devices (e.g., proximately located within wireless communication system) may be triggered in a manner that avoids collisions between their transmissions. In some embodiments, controlled beamforming functions may be implemented by the source (e.g., gNb, UE, etc.), where the source is configured to control and/or limiting the number of ambient IoT devices that are activated and may utilize resources.

The beamforming circuitry 154 may be configured to execute controlled beamforming functions that include controlling an energizing signal beam width. For example, the source (e.g., gNB) may execute control of the beamwidth of an energizing signal. Accordingly, the controlled beam (e.g., having a specified width using controlled beamforming) may be directed towards a more specified (e.g., targeted) subset of the ambient IoT devices, such as ambient IoT device 112. For example, instead of using a relatively wider energizing signal that may activate a large number of ambient IoT devices that may be proximately located in the range of the beam, the source may implement controlled beamforming functions and perform beam sweeping using a controlled energizing signal having a substantially narrow beamwidth that may activate a smaller subset of the IoT devices at any given instance. In some embodiments, the beamwidth for controlled beamforming may be configured per resource pool, and/or the beamwidth for controlled beamforming may be selected from a defined (e.g., pre-configured) set. In some embodiments, if the beamwidth is selected from a defined set, a gNB may indicate to the UE (e.g., in the DCI scheduling the transmission by the UE) an index of the selected beamwidth when it is triggered as an intermediate node.

FIG. 10 depicts an example of a source, shown as a UE 1020 implementing the controlled beamforming for ambient IoT devices 1001-1007, as disclosed herein. As illustrated in FIG. 10, the plurality of ambient IoT devices 1001-1007 may be proximately location within a physical location of a wireless communication environment. The UE 1020 may be configured to control the width of an energizing beam 1030, for instance effectuating a narrower beamwidth for the energizing beam 1030. The UE 1020 may execute beamforming functions that involves directing the controlled energizing beam 1030 (having a narrow width) in a specified direction within the area of the wireless communication environment at a set time slot. In the example, the UE 1020 may point the controlled energizing beam 1030 at a first time slot (e.g., slot 1) in a specified direction such that a subset of ambient IoT devices 1001, 1002 in the smaller area swept by the controlled energizing beam 1030 may be activated during this slot. The UE 1020 may continue executing controlled beamforming functions, as disclosed herein, such that the controlled energizing beam 1030 is pointed in another directed at a second time slot (e.g., slot 2) activating IoT device 1004; and the controlled energizing beam 1030 is pointed in another directed at a third time slot (e.g., slot 2) activating another subset of IoT devices 1006, 1007 within the area of the wireless communication environment.

The beamforming circuitry 154 may be configured to execute controlled beamforming functions that control of the signal strength of the energizing signal. For example, a source can utilize the transmission power (e.g., signal strength) of the energizing signal to further control the number of responding ambient IoT devices at any given slot. Transmission power thresholds for controlled beamforming may be set (e.g., pre-configured) per resource pool. For example, each transmission power threshold may correspond to a different target ambient IoT device range. Subsequently, a source may sweep utilizing a specified transmission power in subsequent instances (along with a specified beam direction), in order to perform a two-dimensional sweeping in controlled beamforming functions. In some embodiments, a maximum (e.g., largest) transmission power may be set in order to trigger all the ambient IoT devices within a specified beamwidth.

Accordingly, controlled beamforming may include functions that can prevent an ambient IoT device 112 from responding to the same energizing signal (e.g., based on a process ID) more than one time within a set (e.g., pre-configured) duration and/or by explicit signaling from the source in the control signaling segment. For example, the source can signal a beamforming parameter (e.g., process ID) in each beam sweeping transmissions to ambient IoT devices. The ambient IoT device 112 may be configured to respond only once to a beam sweeping transmission with the same parameter (e.g., process ID does not change). In some embodiments, the beamforming parameter may be implemented as a bit and/or indicator deemed suitable, such that the beamforming parameter can effectively signal to the ambient IoT device 112 to respond if it can be determined that the beamforming parameter has been updated (e.g., toggled) from previous transmissions.

The beamforming circuitry 154 may be configured to execute controlled beamforming functions that control the carrier frequency of the energizing signal (e.g., frequency sweeping). For example, the source can sweep using multiple carrier frequencies with the energizing signal in order to control the number of responding ambient IoT devices. The carrier frequencies for controlled beamforming may be set (e.g., pre-configured) to activate a specified subset (e.g., device type, group, etc.) of ambient IoT devices. A subset of ambient IoT devices may be configured to utilize a specified carrier frequency for the respective energizing signal. The subset of ambient IoT devices may be set (e.g. pre-configured) to utilize a specified carrier frequency and/or dynamically assigned to utilize a specified carrier frequency by the source. For example, if the ambient IoT device 112 is triggered and was not previously attached to a source (e.g., a clusterhead), the beamforming circuitry 154 may be set (e.g., pre-configured) to identify the carrier to monitor in order to detect the energizing signal. In some embodiments, the beamforming circuitry 154 may be configured to randomly select a carrier to monitor (e.g., from a set of pre-configured carriers) in a manner that may reduce the chances of collisions (e.g., a large number of devices selecting the same carrier for the energizing signal and activating simultaneously). In some embodiments, the beamforming circuitry 154 may be configured to perform sweeping across a set of multiple carriers in different time slots, until it detects the energizing signal. In some embodiments, for example when the ambient IoT device is attached to a source, the source may be configured to indicate to the ambient IoT device 112 which frequency to monitor.

In some embodiments, controlled beamforming functions may utilize different carrier frequencies for different priority transmissions. The correspondence between carrier frequencies and priority for controlled beamforming functions may be set (e.g., pre-configured) and/or dynamically assigned. Beamforming functions that control the carrier frequency of the energizing signal may also reduce the number of responding ambient IoT devices at any given instant in a manner that reduces the number of potential collisions.

The beamforming circuitry 154 may be configured to execute controlled beamforming functions that control the duration of the energizing signal. For example, an energizing signal controlled to have a relatively shorter duration can be used to activate a specified subset (e.g., device types) of ambient IoT devices (e.g., type-A ambient IoT devices). In some embodiments, an energizing signal controlled to have a relatively longer duration may be utilized to trigger a different subset (e.g., device types) of ambient IoT devices (e.g., type-B ambient IoT devices). For example, type-B ambient IoT devices may utilize a longer duration of time to charge (e.g., onboard energy storage unit) with the energizing signal before performing their back scattered transmission, which lends this group of ambient IoT devices to be assigned to a controlled increased (e.g., long) duration. In some embodiments, controlling the duration of the energizing signal may be timer-based. For example, a subset of ambient IoT device (e.g., device type) may be configured to respond if it receives the energizing signal for a set (e.g., configured) timed duration. In some embodiments, the beamforming functions may utilize multiple set timers (controlling the duration of the energizing signal) that are each configured to trigger a different subset of ambient IoT devices.

The beamforming circuitry 154 may be configured to execute controlled beamforming functions that control the type of energizing signal. In some embodiments, the source (e.g., gNB) may be configured to send different types of energizing signals to trigger a specified subset of ambient IoT devices. For example, if a source uses an intermittent (on/off) energizing signal, a specified subset of ambient IoT device (e.g., type or priority) may respond; and if the source uses a contiguous energizing signal is a different subset of IoT devices (e.g., type or priority) may respond. In some embodiments, the correspondence between the type energizing signal and/or the subset of IoT devices that are triggered for controlled beamforming may be set (e.g., pre-configured) per resource pool, and/or may be dynamically assigned by the source (e.g., by the cluster head when devices join the cluster).

The beamforming circuitry 154 may be configured to execute controlled beamforming functions that utilize coded energizing signals. In some embodiments, a combination of energizing signals can be used to indicate the subset of ambient IoT devices that are expected to respond. For instance, sending energizing signals on specified carriers (e.g., carrier frequency f₁ and carrier frequency f₂) can trigger a subset of ambient IoT devices; and sending the energizing signals on different specified carriers (e.g., carrier frequency f₁ and carrier frequency f₃) can trigger another subset of ambient IoT devices. The correspondence between the energizing signal code and the subset of ambient IoT devices (e.g., priority, device type, location, etc.) for controlled beamforming may be set (e.g., pre-configured), and/or may be dynamically assigned by the source. The ambient IoT device 112 may be able to indicate its location to the source (e.g., in UL reporting), for example if the ambient IoT device 112 is stationary, in order to support beamforming control function utilizing location. If ambient IoT device 112 is mobile (or not aware of its location), the source can utilize the measured signal strength of the UL signal to identify a relative location of the ambient IoT device 112 to the source.

In some embodiments, a priority for subsets of ambient IoT devices may be set (e.g., pre-configured) per resource pool, and/or may be assigned by the source to implement beamforming control functions utilizing priority. For example, mobile (e.g., fast moving) ambient IoT devices may be assigned a higher priority than fixed (or slot moving) ambient IoT devices, because the transmission window is expected to be relatively shorter for the ambient IoT devices. In some embodiments, if the source is the gNB, parameters utilized for beamforming functions, as disclosed herein, may be determined and/or configured by the gNB implementation. In some embodiments, if the source is the UE, parameters utilized for beamforming functions, as disclosed herein, may be configured by the gNB and then sent to the source UE.

The guided random resource selection circuitry 155 may be configured to control resource selection for ambient IoT devices based on determining preferred resources and/or non-preferred resources. The guided random resource selection circuitry 155 may enable the ambient IoT device 112 to declare resource(s) that it may use in its future UL transmission (e.g., the following repetitions of the same TB) to the source. For example, the guided random resource selection circuitry 155 can generate an indication that declares that resources that the ambient IoT device 112 intends to use for a future transmission. The indication of future resources may be included in a signal from the ambient IoT device 112 to the source, which in turn, can then forwarded by the source to other ambient IoT devices (when they are triggered). Because the other proximately located ambient IoT devices are aware of resource that may be utilized by the ambient IoT device 112 for an upcoming transmission, resource allocation may be performed in manner that can avoid collisions. In some embodiments, the source may identify resources that the ambient IoT device 112 intends to use for future transmission (indicated in the signal) as its “preferred” resources. The source may receive similar indications of future resources from the other nearby ambient IoT devices. The source can use these indications to determine which resources are “reserved” by other nearby ambient IoT devices, and therefore can identify these resources as “non-preferred” resources for the ambient IoT device 112 because of the likelihood of collision. In some embodiments, a DL transmission may trigger an UL transmission from the ambient IoT device 112, and the indication of future resources for nearby ambient IoT devices can be included in the control signaling (from the source) for the upcoming UL transmission of the ambient IoT device 112 to indicate the “non-preferred” resources (e.g., resources that are “reserved” by other nearby IoT devices). Accordingly, the “non-preferred” resources determined by the source, may be avoided while the ambient IoT device 112 performs random access selection of resources for the UL transmission. In some embodiments, the indication of future resources may be implemented by the guided random resource selection circuitry 155 as a bit and/or other suitable indication to specify that the ambient IoT device intends to perform a future transmission.

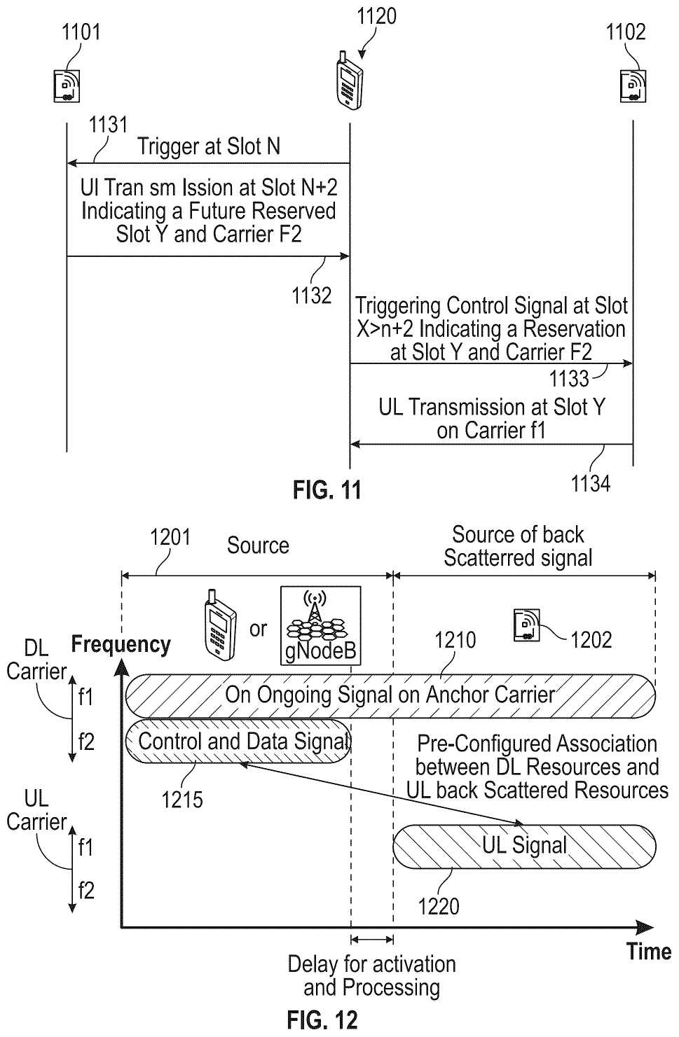

FIG. 11 depicts an example of a communication flow between a source, shown as the UE 1120, and ambient IoT devices 1101, 1102 that may be implemented by the guided random resource selection functions, as disclosed herein. The UE 1120 may communicate a signal 1131 that triggers the ambient IoT device 1101. The ambient IoT device 1102, triggered to perform an UL transmission, may then select resources for the future transmission (e.g., future resources can be for other TB segments or retransmissions of a current TB). Thus, the ambient IoT device 1102 may communicate a signal 1132 to the UE 1120 to perform an UL transmission (e.g., at slot N+2), which includes an indication of the resources the ambient IoT device has selected for a future transmission. For example, the signal 1132 communicated from the ambient IoT device 1101 may indicate that it intends to utilize specified resources (e.g., slot Y, and carrier f₂) to be reserved for a future UL transmission.

In response to receiving the signal 1132, the UE 1120 may utilize the “reservation” of future resources indicated by the ambient IoT device 1101, and accordingly determine that these resources (e.g., slot Y, and carrier f₂) as non-preferred resources for other nearby ambient IoT devices, such as ambient IoT device 1102. In some embodiments, the UE 1120 can aggregate the indication of “reserved” future resources from other nearby ambient IoT devices and accordingly establish a preferred/non-preferred list of resources. The UE 1120 may communicate a signal 1133 to ambient IoT device 1102, which may be a control signal (at slot X, where X>N+2) to trigger the ambient IoT device. In the control signal from UE 1120, the list of preferred/non-preferred resources may be included (e.g., through control signaling). In some embodiments, the UE 1120 may indirectly (e.g., by adjusting the energizing signal duration) indicate the list of preferred/non-preferred resources to the ambient IoT devices. The signal 1133 may indicate to the ambient IoT device 1102 that the resources (e.g., slot Y, and carrier f₂) are already reserved by the ambient IoT device 1101.

The ambient IoT device 1102 can perform resource selection based on the indicated “reservation” of the future resources. The guided random resource selection functions implemented by the ambient IoT device 1102, as disclosed herein, may prevent the non-preferred resources from being selected in the process to avoid collision. For example, the ambient IoT device 1102 may perform resource reselection if a collision associated with resources “reserved” by other ambient IoT devices is detected by the guided random resource selection functions. The ambient IoT device 1102 may communicate a signal 1134 to the UE 1120 to perform an UL transmission. For example, the ambient IoT device 1102 may communicate the signal 1134 that indicates resources (slot Y, carrier F₁) for the UL transmission that have been selected to mitigate collision based on the signaling of the preferred and/or non-preferred resources.

Referring again to FIG. 2, the guided random resource selection circuitry 155 may implement broadcast/multicast signaling to indicate future resources (e.g., on triggering UL transmission). The source may provide a resource reservation status periodically utilizing a broadcast/multicast signal that nearby ambient IoT devices can receive. In the broadcast/multicast signal, the source may indicate which ambient IoT device is triggered at a slot (e.g., slot N) and which carriers to use (e.g., carriers f₁ and f₂). Subsequently, the triggered ambient IoT device can perform the UL transmission and request more resources to be scheduled by the source, and/or the ambient IoT device can select a resource (e.g., locally and/or randomly) and accordingly indicate the selected resource to the source. In a subsequent broadcast, the source can indicate that the next slots are reserved for a subset of ambient IoT devices (e.g., device types) based on the information received from the device and/or based on the scheduled resources from the source based on the request from the ambient IoT device. Other proximately located ambient IoT devices may perform a random selection from among the resources (e.g., carriers) that are not reserved, as indicated in the broadcast/multicast signals from the source.

In some embodiments, the source may perform guided random resource selection functions that indicate a back-off (or random weight) factor that can be used in the random selection operation. These parameters may be adjusted, for example by the source, to control collision probability based on the received future reserved resources by the ambient IoT devices and/or the future resources that are scheduled by the source in its DL transmissions.

In some embodiments, a DL transmission can include in its control signaling the resources that the ambient IoT device may use when performing their random-access selection (e.g., by providing a preferred resource set rather than a non-preferred resource set). For example, the DL control signaling can indicate that out of channels 1-4, only channels 1 and 3 should be used for random access in a current instance due to the expected UL transmissions from nearby ambient IoT devices.

In some embodiments, the source may consider several factors related to the performance of the wireless communication system (e.g., overhead, latency, etc.), before communicating the future resource “reservation” information from ambient IoT devices. For instance, the source may consider the overall system occupancy and an expected number of future ambient IoT devices that are expected to be triggered. For example, if a system is highly occupied, then information indicated the future reserved resources might not be forwarded to allow the upcoming high priority transmissions (e.g., perform a pre-emption as discussed herein). Alternatively, the source may communicate the future reservations information however, this information can be restricted to low priority transmissions. For example, the non-preferred resources may be signalled to a subset of the ambient IoT devices that are expected to have lower priority.

In some embodiments, the list of preferred and/or non-preferred resources can be explicitly indicated in the control signaling sent from the source to the ambient IoT devices (e.g., when performing triggering). For example, one or more TRIV and FRIV fields can be used to indicate the reserved and/or available resources for future transmissions. This indication can be implemented as a time indication (i.e., the source can indicate the slots that are occupied and/or available without any frequency indication). In some embodiments, the future resource indication can also be embedded within the energizing signal, where transmitting the energizing signal on a specified carrier (e.g., carrier X) at a specified slot (e.g., slot Z) can indicate that this carrier is available for UL transmissions for a determined number of slots (e.g., Y slots, where Y can be a configured parameter per resource pool).

In some embodiments, guided random resource selection circuitry 155 may be configured to implement the functions related to validity of the received future reservations. For example, a validity of the future reservations can be indicated by the ambient IoT device that performed the reservation. The ambient IoT device 112 can indicate a validity of the future reservations by further indicating the carrier(s) that it intends to reserve, and the duration for which the carrier(s) are to be reserved. In some embodiments, the validity of the reservation can be based on the supported device types and the duration of the energizing signal. This is because, some types of ambient IoT device (e.g., type A devices, and type B devices) may depend on the energizing signal for activation and back scattering, and thus the validity of their future reservation can be dependent on the energizing signal. However, since ambient IoT devices can have an on-board energy storage, an offset may be applied on top of the energizing signal to obtain an evaluation of the validity of the future reservation.

In some embodiments, the guided random resource selection circuitry 155 may be configured to determine a duration of the energizing signal having a suitable and/or optimal length for supporting several functions, including the guided random resource selection functions described herein. Fo example, the source may be configured to ensure that the energizing signal is long enough to allow the ambient IoT devices to perform the random access procedure and subsequently transmit their signals using back scattering. The duration of the energizing signal may be configured such that the length of time can support device functions, including, but not limited to: activation; decoding of the DL control signal; charging of the on board energy storage; and performing the back scattered transmission to the source. The duration may be based on the factors related to the ambient IoT device that is being supported, such as the device type, supported priorities (due to its impact on the back off and contention window sizes in case of sensing before transmitting). Some ambient IoT devices may randomly select a number from the contention window size and accordingly perform sensing for this duration before transmitting where the contention window size is dependent on priority. In some embodiments, the duration of the energizing signal can be determined and represented mathematical as:

$${T}_{total} = {T}_{1} + {T}_{2} + {T}_{3} + {T}_{4} + {T}_{5} + {T}_{6} \qquad ( eq . 1 )$$

where T₁ refers to the time used for device activation and initial energy harvesting;
T₂ refers to the time used to receive and process the DL control signaling,
T₃ refers to the time used to charge the onboard energy storage and is dependent on the supported device type (e.g., shorter if only device Type C or device Type A is supported in the resource pool),
T₄ refers to the time used for the largest contention window size based on the supported or scheduled ambient IoT device priorities,
T₅ refers to the time used for backscattering, and
T₆ refers to an offset that is dependent on the number of activated ambient IoT devices (e.g., if the number is larger than a pre-configured threshold(s) then a certain offset is used).

In some embodiments, if the source of the energizing signal is a UE, then the gNB may schedule resources for the energizing signal for the UE to operate without collision. This may be performed by indicating indication an energizing signal duration to the gNB (e.g., using a new uplink control signaling format or a new MAC CE).

The reduced signaling and association circuitry 156 may be configured to implement signaling of previously detected ambient IoT devices (using an association between the UL and DL transmissions) to reduce the number of responding devices, and thereby reduce collisions between proximately located IoT devices. According to wireless communication technology standards, it may be expected for UL transmissions from the ambient IoT devices to be triggered by a DL transmission from the source. Reduced signaling functions, as disclosed herein, can leverage this associated between the UL and DL transmissions in a manner that can reduce the number of previously reported ambient IoT devices that retransmit and ultimately mitigate collisions between UL transmissions (e.g., by decreasing the number of responding device).

FIG. 12 depicts an example of a one-to-one association that can be established between an DL transmission from a source 1201 and an UL transmission from an ambient IoT device 1202. FIG. 12 illustrates that the source 1201, shown as a UE and/or gNB, may transmit an energizing signal 1210 (or anchor carrier) to the ambient IoT device 1202.

For example, the energizing signal 1210 can be a unicast trigger for the ambient IoT device 1202. During this time (e.g., duration of the energizing signal 1210 for energy harvesting), the source 1201 may transmit in a DL transmission a control and data signal 1215 to the ambient IoT device 1202 (e.g., transmitting in slot X and subchannel/carrier Y). The control and data signal 1215 may be configured to include an indication of the corresponding ambient IoT device 1202 that is being triggered for an UL transmission (e.g., generating the UL transmission where Z is a configured offset that can be fixed or time varying based on a configured sequence for frequency diversity). For example, the control and data signal 1215 can include a target device ID and/or field within the control signaling that corresponds to the receiving ambient IoT device 1202.

In response, the ambient IoT device 1202 can transmit an UL signal 1220 to the source 1201 including the same indication (e.g., transmitting in slot X+N and carrier Y+Z where N is a configured minimum latency to allow for the processing of the received control signaling). For example, the UL signal 1220 to the source 1201 can include the target device ID. Thus, by utilizing the indication in both the DL transmission from the source 1201 and the triggered UL transmission from the ambient IoT device 1201, a one-to-one mapping between a DL transmission (e.g., DL resource) and an UL transmission (e.g., UL resource) may be established.

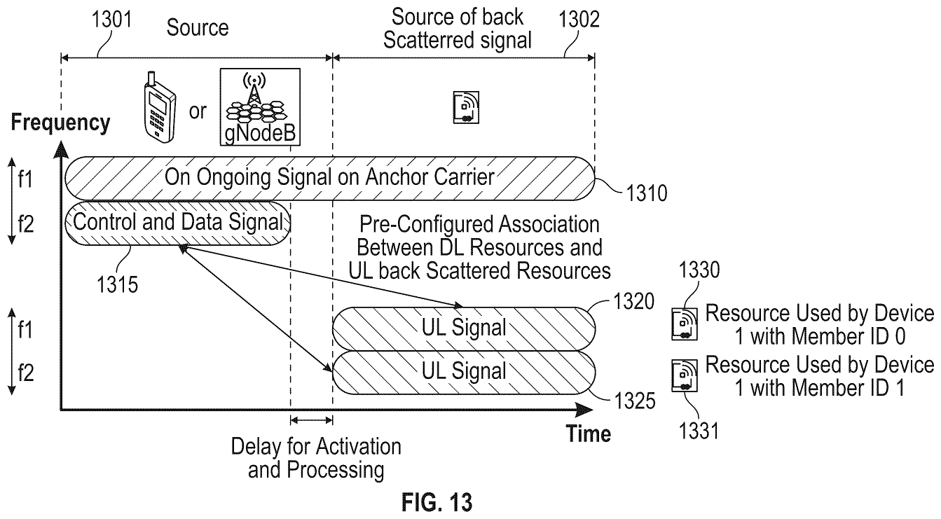

FIG. 13 depicts an example of a one-to-many association that can be established between an DL transmission from a source 1301 and an UL transmission from an ambient IoT device 1302. FIG. 13 illustrates that the source 1301, shown as a UE and/or gNB, may transmit an energizing signal 1310 (or anchor carrier) to the ambient IoT device 1302.

For example, the energizing signal 1210 can be a groupcast trigger for the ambient IoT device 1302. During this time, the source 1301 may transmit in a DL transmission a control and data signal 1315 to the ambient IoT device 1302. The control and data signal 1315 may be configured to include a groupcast ID and/or a new field within the control signaling that corresponds to the receiving ambient IoT device 1302. For instance, the source 1301 can indicate in its DL control and data signal 1315 (e.g., by using a new field) the number of resources that will be reserved for the group to use for the UL transmissions.

For instance, the source 1301 can provide an index of the number of resources reserved for the UL transmission. The number of resources can be a number of time slots and/or a number of carriers/subchannels. These resources can also be identified as a sequence of resources that occur in one slot or in multiple consecutive/non-consecutive slots. For example, a sequence can indicate that carriers f1, f4, f10 of slot X can be used or it can indicate a set of time/frequency pairs such as {(Slot Y, f1), (Slot X, f2}, (SlotZ,f1}}. In addition, each ambient IoT device within the groupcast can be assigned a member ID by which it identifies the resources to use for its transmission. For example, the source 1301 can provide an index in its DL assignment indicating a reservation of 4 slots starting from slot X+N and 3 carriers/subchannels starting from Y+Z. In some cases, the ambient IoT devices within the groupcast can randomly select or perform energy detection before selecting the UL resources from the associated resource set. This can be beneficial when the associated resource set is smaller than the number of the members of the group and/or if the number of groupcast members is not known (e.g., random approach can be indicated by the source 1301 in the DL by using a one-bit field in the control signaling to indicate whether the associated UL resources are dedicated or are available for random selection).

In response, the ambient IoT device 1302 can transmit an UL signal 1320 via a first UL resource 1330 (with member ID 0) to the source 1301 and an UL signal 1325 via a second resource 1331 (with member ID 1) to the source 1301. Thus, by utilizing the indication (e.g., groupcast ID, reserved resources) in both the DL transmission from the source 1301 and the triggered UL transmissions 1320, 1325 from the ambient IoT device 1302, a one-to-many mapping between a DL transmission (e.g., DL resource) and the UL transmissions (e.g., UL resources) may be established.

In some embodiments, for example in the case of a broadcast triggering of ambient IoT devices, the number of responding ambient IoT devices may not be known and thus a one-to-one DL/UL association may might be optimal in resolving collisions. However, in the broadcast indication, a source can indicate that a subset of the available resources is reserved for access by the higher priority ambient IoT devices. In this case, similar to the groupcast signaling shown in FIG. 13, the source can provide an index that is mapped to a set of slots and carriers/subchannels to be used by the high priority ambient IoT devices. In addition, the source can also specify the priority threshold (e.g., selected from a configured set), where the ambient IoT devices with transmission priorities above this threshold are allowed to use the indicated resources. Thus, collisions between high priority and low priority transmissions may be reduced.

In some embodiments, an association between UL transmissions and/or DL transmission can be established in case of a frequency division duplexing (FDD) spectrum, where the DL resource can be associated with one or more UL resources in the UL carrier. Similarly, the association can also be established in a time division duplex (TDD) spectrum, where DL resources may be associated with one or more resources that are utilized in a later slot. The association can be dynamically determined and/or indicated in the control signaling. The source can use multiple sets of TRIV/FRIV fields to indicate an association with a set of resources in the UL resource pool. Alternatively, the resources can be indicated as a block in which the source indicates the starting slot and carrier/subchannel in addition to a new field indicating the number of reserved slots and another field indicating the number of reserved subchannels. The number of reserved slots indicated by the source can be physical slots and/or logical slots based on the resource pool configuration.

Referring again to FIG. 2, the reduced signaling and association circuitry 156 can be configured to leverage the associations established between UL/DL transmissions to reduce signaling of previously detected devices (e.g., on pre-configured resources). For example, a source can provide a set of UL transmissions from the nearby ambient IoT devices. Subsequently, the ambient IoT device 112 that received the DL message, may compare it against its locally generated message and accordingly refrain from transmitting if the message is already included in the DL. Thus, the reduced signaling and association circuitry 156 can enable the ambient IoT device 112 to then utilize a simplified UP message (e.g., an ACK/NACK, an ACK only, or a confirmation message) instead of sending the full expected message. The reduce signaling may be lower consumption of the UL resources thus reducing collisions between ambient IoT devices.

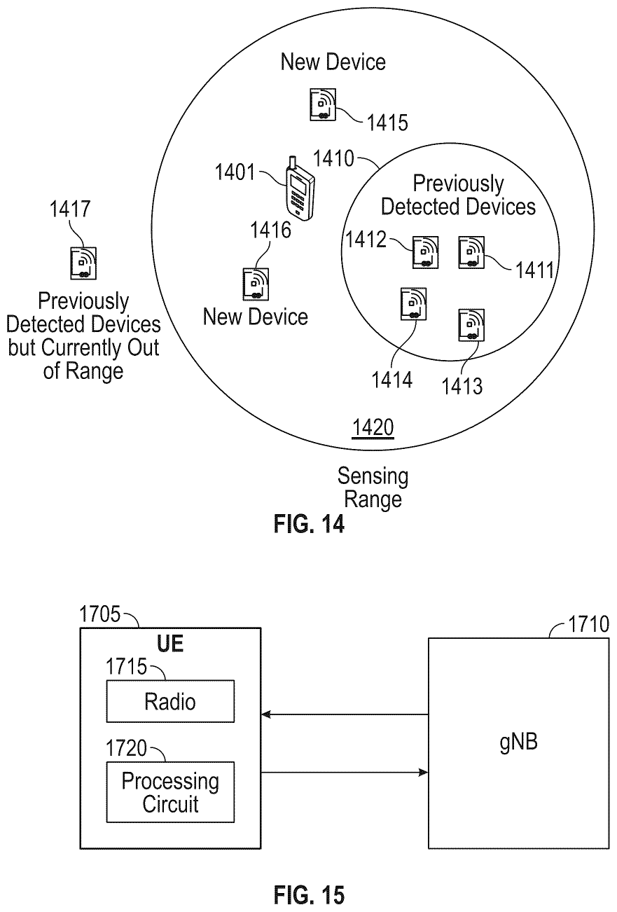

FIG. 14 depicts an example of a wireless communication environment implementing reduced signaling for a plurality of ambient IoT devices 1411-1417 in a manner that may reduce collisions. In the example, the source 1401, shown as a UE, is may establish wireless sensing within a sensing range 1420, for example to perform asset tracking of ambient IoT devices 1411-1417. In this example, the source 1401 may have previously performed wireless sensing, where the ambient IoT devices 1411-1414 and 1417 were detected and/or identified by the source 1401 in its asset tracking functions. In some embodiments, when the ambient IoT devices 1411-1417 are detected by wirelesses sensing and perform the response communication, they have the capability to transmit an identifier, such as device ID, to the source 1401. Thus, the source 1401 can identify the previously detected ambient IoT devices 1411-1414 and 1417 based on the device IDs received in the prior wireless sensing action. In a current wireless sensing action, the ambient IoT devices 1411-1416 are illustrated as being within a boundary of the source 1401 sensing range 1420 and may be detected. In the example, the ambient IoT devices 1411-1414 may have been previously detected (prior wireless sensing action) based on the corresponding device IDs and the ambient IoT devices 1415, 1416 are newly detected based on the corresponding device IDs. Additionally, FIG. 14 illustrates an ambient IoT device 1417 that may have been previously detected in the prior wireless sensing action but now may be out of the sensing range 1420 for this wireless sensing by the source 1401. The source 1401 may transmit an indication in its control signaling of the previously detected devices on configured resources. For example, the source 1401 may communicate the device IDs for previously detected ambient IoT devices 1411-1414 in the control signal during the current wireless sensing action. The previously detected ambient IoT devices 1411-1414 may be configured to not transmit again to the source 1401 in this current wireless sensing action, and/or to transmit a reduced payload (e.g., a simple ACK) to the source 1401. In some embodiments, the resources to be used for the reduced payload may be indicated to the ambient IoT devices 1411-1414 from the source 1401 (e.g., by unicast scheduling, a pool for random resource selection by the devices, etc.). The simple ACK can be a sequence wherein multiple ambient IoT devices can send orthogonal sequences based on their assigned resources from the reader.

In FIG. 14, the source 1401 can indicate previously detected ambient IoT devices 1411-1414 by including their device IDs in the DL control signaling. As shown in Error! Reference source not found., four of the ambient IoT devices 1411-1414 were previously detected and thus their IDs would be included along with their prospective payload. Subsequently, the ambient IoT devices 1411-1414 may not have to perform a complete transmission, but rather an ACK/NACK and/or an ACK confirmation to reduce the UL signaling overhead. In addition, since one of the previously detected ambient IoT devices 1417 became out of range, no response will be received at the source 1401, and thus can be considered as a NACK.

FIG. 14 also illustrates that there are ambient IoT device 1415, 1416 that have become within range and thus these two devices can then be triggered by the source 1401 (e.g., in case of a broadcast trigger) to perform an UL transmission and accordingly transmit a payload to the source. Accordingly, the number of ambient IoT devices performing an UL transmission in accordance with the reduced signaling function, as disclosed herein, can be significantly reduced. The reduced signaling functions, by reducing the number of responding devices, may also reduce collisions thereby improving the reliability of the UL transmission. In some embodiments, the ACK/NACK message transmitted by ambient IoT devices may be sent with a larger number of repetitions than the UL transmission to improve its reliability. In addition, since the ACK/NACK messages are expected to be relatively smaller and/or shorter than response messages, collisions between the responses from the ambient IoT device may be reduced.

In some embodiments, the reduced signaling and association circuitry 156 may be configured to control how the ambient IoT devices can be signalled and/or triggered. The reduced signaling and association circuitry 156 may utilize DL control signaling to control signaling and/or triggering the ambient IoT devices. The source may indicate in its downlink signaling the device IDs of the targeted ambient IoT devices that were previously detected and a payload that was previously received from these ambient IoT devices. The DL control signaling for triggering may carry this information, and/or it can be carried in an independent set of resources. The set of resources may be configured per resource pool and can be monitored by the ambient IoT devices on an as-need basis (e.g., previously performed a transmission or if they are associated with a cluster head). In some cases (e.g., massive sensing), the source can send a broadcast transmission to trigger a large number of ambient IoT devices and a control signal indicating the previously reported measurement and/or an expectation of the current measurement. Subsequently, the ambient IoT devices that receive the trigger and identify that their messages are associated with the message received on the DL transmission may not perform the UL transmission, thereby improving efficiency of UL resources and reducing the chances of collisions between the UL transmissions.

In some embodiments, the reduced signaling and association circuitry 156 may be configured to control the resources used for reduced signaling functions from the ambient IoT devices. The transmissions for reduced signaling (e.g., UL including a simple ACK) can be directly scheduled by the source and may be directly associated with the IDs transmitted on the DL. For example, if the source indicated a specified number of IDs in its DL, it can then schedule the same number of UL resources with a one-to-one association between each of the IDs in DL and the UL resources used to carry the UL message. Alternatively, the source may provide a pool of resources that may be configured, and/or indicated in the DL as resources to be used by the ambient IoT devices. The ambient IoT devices may randomly select a resource for transmission on the UL, in some embodiments. By controlling the resources utilizing in reduced signally, the resource consumption in the system may be reduced (e.g., a reduced uplink message is expected to consume less resources when compared to the full UL message) and may improve efficiency in systems that include a large number of ambient IoT devices (e.g., broadcast triggering of a large number of ambient IoT devices).

FIG. 15 shows a system including a UE 1705 and a gNB 1710, in communication with each other. The UE may include a radio 1715 and a processing circuit (or a means for processing) 1720, which may perform various methods disclosed herein, e.g., the functions and methods illustrated in FIG. 1. For example, the processing circuit 1720 may receive, via the radio 1715, transmissions from the network node (gNB) 1710, and the processing circuit 1720 may transmit, via the radio 1715, signals to the gNB 1710.

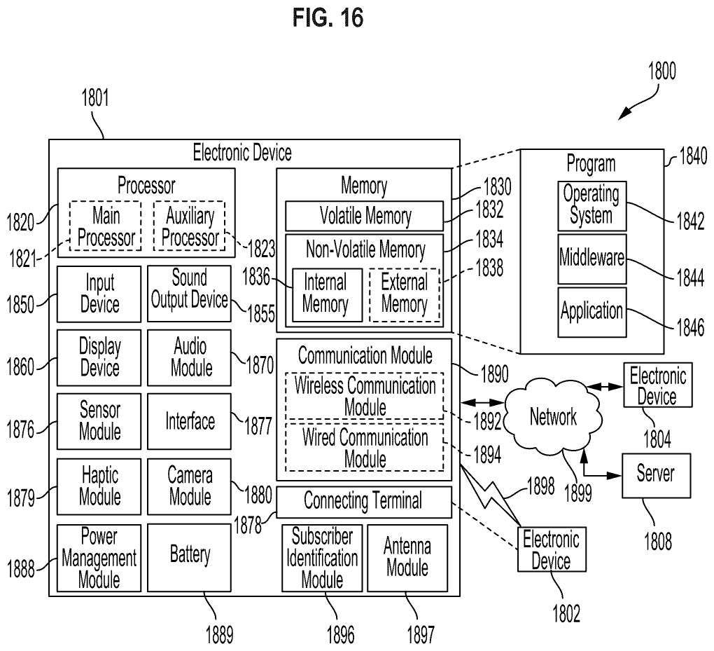

FIG. 16 is a block diagram of an electronic device in a network environment, according to some embodiments of the present disclosure.

Referring to FIG. 16, an electronic device 1801 in a network environment 1800 may communicate with an electronic device 1802 via a first network 1898 (e.g., a short-range wireless communication network), or with an electronic device 1804 or a server 1808 via a second network 1899 (e.g., a long-range wireless communication network). The electronic device 1801 may communicate with the electronic device 1804 via the server 1808. The electronic device 1801 may include a processor 1820, a memory 1830, an input device 1850, a sound output device 1855, a display device 1860, an audio module 1870, a sensor module 1876, an interface 1877, a haptic module 1879, a camera module 1880, a power management module 1888, a battery 1889, a communication module 1890, a subscriber identification module (SIM) card 1896, and/or an antenna module 1897. In one embodiment, at least one of the components (e.g., the display device 1860 or the camera module 1880) may be omitted from the electronic device 1801, or one or more other components may be added to the electronic device 1801. Some of the components may be implemented as a single integrated circuit (IC). For example, the sensor module 1876 (e.g., a fingerprint sensor, an iris sensor, or an illuminance sensor) may be embedded in the display device 1860 (e.g., a display).

The processor 1820 may execute software (e.g., a program 1840) to control at least one other component (e.g., a hardware or a software component) of the electronic device 1801 coupled to the processor 1820, and may perform various data processing or computations.

As at least part of the data processing or computations, the processor 1820 may load a command or data received from another component (e.g., the sensor module 1876 or the communication module 1890) in volatile memory 1832, may process the command or the data stored in the volatile memory 1832, and may store resulting data in non-volatile memory 1834. The processor 1820 may include a main processor 1821 (e.g., a central processing unit or an application processor (AP)), and an auxiliary processor 1823 (e.g., a graphics processing unit (GPU), an image signal processor (ISP), a sensor hub processor, or a communication processor (CP)) that is operable independently from, or in conjunction with, the main processor 1821. Additionally or alternatively, the auxiliary processor 1823 may be adapted to consume less power than the main processor 1821, or to execute a particular function. The auxiliary processor 1823 may be implemented as being separate from, or a part of, the main processor 1821.

The auxiliary processor 1823 may control at least some of the functions or states related to at least one component (e.g., the display device 1860, the sensor module 1876, or the communication module 1890), as opposed to the main processor 1821 while the main processor 1821 is in an inactive (e.g., sleep) state, or together with the main processor 1821 while the main processor 1821 is in an active state (e.g., executing an application). The auxiliary processor 1823 (e.g., an image signal processor or a communication processor) may be implemented as part of another component (e.g., the camera module 1880 or the communication module 1890) functionally related to the auxiliary processor 1823.

The memory 1830 may store various data used by at least one component (e.g., the processor 1820 or the sensor module 1876) of the electronic device 1801. The various data may include, for example, software (e.g., the program 1840) and input data or output data for a command related thereto. The memory 1830 may include the volatile memory 1832 or the non-volatile memory 1834.

The program 1840 may be stored in the memory 1830 as software, and may include, for example, an operating system (OS) 1842, middleware 1844, or an application 1846.

The input device 1850 may receive a command or data to be used by another component (e.g., the processor 1820) of the electronic device 1801, from the outside (e.g., a user) of the electronic device 1801. The input device 1850 may include, for example, a microphone, a mouse, or a keyboard.

The sound output device 1855 may output sound signals to the outside of the electronic device 1801. The sound output device 1855 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 1860 may visually provide information to the outside (e.g., to a user) of the electronic device 1801. The display device 1860 may include, for example, a display, a hologram device, or a projector, and may include control circuitry to control a corresponding one of the display, hologram device, and projector. The display device 1860 may include touch circuitry adapted to detect a touch, or may include sensor circuitry (e.g., a pressure sensor) adapted to measure the intensity of force incurred by the touch.

The audio module 1870 may convert a sound into an electrical signal and vice versa. The audio module 1870 may obtain the sound via the input device 1850 or may output the sound via the sound output device 1855 or a headphone of an external electronic device 1802 directly (e.g., wired) or wirelessly coupled to the electronic device 1801.

The sensor module 1876 may detect an operational state (e.g., power or temperature) of the electronic device 1801, or an environmental state (e.g., a state of a user) external to the electronic device 1801. The sensor module 1876 may then generate an electrical signal or data value corresponding to the detected state. The sensor module 1876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 1877 may support one or more specified protocols to be used for the electronic device 1801 to be coupled to the external electronic device 1802 directly (e.g., wired) or wirelessly. The interface 1877 may include, for example, a high-definition multimedia interface (HDMI), a universal serial bus (USB) interface, a secure digital (SD) card interface, or an audio interface.

A connecting terminal 1878 may include a connector via which the electronic device 1801 may be physically connected to the external electronic device 1802. The connecting terminal 1878 may include, for example, an HDMI connector, a USB connector, an SD card connector, or an audio connector (e.g., a headphone connector).

The haptic module 1879 may convert an electrical signal into a mechanical stimulus (e.g., a vibration or a movement) or an electrical stimulus, which may be recognized by a user via tactile sensation or kinesthetic sensation. The haptic module 1879 may include, for example, a motor, a piezoelectric element, or an electrical stimulator.

The camera module 1880 may capture a still image or moving images. The camera module 1880 may include one or more lenses, image sensors, image signal processors, or flashes. The power management module 1888 may manage power that is supplied to the electronic device 1801. The power management module 1888 may be implemented as at least part of, for example, a power management integrated circuit (PMIC).

The battery 1889 may supply power to at least one component of the electronic device 1801. The battery 1889 may include, for example, a primary cell that is not rechargeable, a secondary cell that is rechargeable, or a fuel cell.

The communication module 1890 may support establishing a direct (e.g., wired) communication channel or a wireless communication channel between the electronic device 1801 and the external electronic device (e.g., the electronic device 1802, the electronic device 1804, or the server 1808), and may support performing communication via the established communication channel. The communication module 1890 may include one or more communication processors that are operable independently from the processor 1820 (e.g., the AP), and may support a direct (e.g., wired) communication or a wireless communication. The communication module 1890 may include a wireless communication module 1892 (e.g., a cellular communication module, a short-range wireless communication module, or a global navigation satellite system (GNSS) communication module) or a wired communication module 1894 (e.g., a local area network (LAN) communication module or a power line communication (PLC) module). A corresponding one of these communication modules may communicate with the external electronic device via the first network 1898 (e.g., a short-range communication network, such as BLUETOOTH™, wireless-fidelity (Wi-Fi) direct, or a standard of the Infrared Data Association (IrDA)), or via the second network 1899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1892 may identify and authenticate the electronic device 1801 in a communication network, such as the first network 1898 or the second network 1899, using subscriber information (e.g., international mobile subscriber identity (IMSI)) stored in the subscriber identification module 1896.

The antenna module 1897 may transmit or receive a signal or power to or from the outside (e.g., the external electronic device) of the electronic device 1801. The antenna module 1897 may include one or more antennas. The communication module 1890 (e.g., the wireless communication module 1892) may select at least one of the one or more antennas appropriate for a communication scheme used in the communication network, such as the first network 1898 or the second network 1899. The signal or the power may then be transmitted or received between the communication module 1890 and the external electronic device via the selected at least one antenna.

Commands or data may be transmitted or received between the electronic device 1801 and the external electronic device 1804 via the server 1808 coupled to the second network 1899. Each of the electronic devices 1802 and 1804 may be a device of a same type as, or a different type, from the electronic device 1801. All or some of operations to be executed at the electronic device 1801 may be executed at one or more of the external electronic devices 1802, 1804, or 1808. For example, if the electronic device 1801 should perform a function or a service automatically, or in response to a request from a user or another device, the electronic device 1801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1801. The electronic device 1801 may provide the outcome, with or without further processing of the outcome, as at least part of a reply to the request. To that end, cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on a non-transitory computer-readable storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A non-transitory computer-readable storage medium can be, or be included in, a computer-readable storage device, a computer-readable storage substrate, a random or serial-access memory array or device, or a combination thereof. Moreover, while a non-transitory computer-readable storage medium is not a propagated signal, a non-transitory computer-readable storage medium may be a source or destination of computer-program instructions encoded in an artificially-generated propagated signal. The non-transitory computer-readable storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above but is instead defined by the following claims.

What is claimed is:

1. A method comprising:
receiving, by a processor, a transmission comprising a channel sensing metric associated with a communication resource within a communication network for a plurality of wireless devices, wherein the plurality of wireless devices comprises ambient Internet of Things (IoT) devices;
determining, by the processor, whether establishing a communication link with the communication resource comprises a collision with one of the plurality of wireless devices in the communication network based on the received channel sensing metric;
selecting, by the processor, the communication resource based on the determination; and
establishing, by a processor, the communication link using the selected communication resource.

2. The method of claim 1, wherein the received channel sensing metric comprises a channel busy ratio (CBR) value received from an intermediate node.

3. The method of claim 2, further comprising measuring the communication resource to obtain a measured CBR value.

4. The method of claim 3, wherein the measuring the communication resource further comprises utilizing a pre-configured CBR value in response to the measured CBR value being insufficient or unavailable.

5. The method of claim 1, wherein the determining is based on a priority-based threshold and a selected CBR selected from the group consisting of the received CBR value, the measured CBR value, and the pre-configured CBR value.

6. The method of claim 2, further comprising transmitting, on the established link using the selected communication resource, an uplink signal during a first time slot and an energy signal during a second time slot.

7. The method of claim 6, wherein the transmitting of the energy signal comprises intermittently transmitting the energy signal in the second time slot based on a priority of the wireless device, wherein a wireless device having a highest priority has a longest transmission duration of the energy signal in the second time slot.

8. The method of claim 6, further comprising transmitting an uplink signal or repetitions of the uplink signal by switching the selected communication resource to a new carrier frequency.

9. The method of claim 1, wherein the transmission comprises additional information comprising an indication of the communication resource being reserved by a wireless device within the communication network based on the wireless device transmitting a future reservation associated with the communication resource to a source device, wherein the selected communication resource is based on the communication resource not being reserved by the wireless device.

10. The method of claim 9, further comprising reselecting a different communication resource based on the indication and transmitting an uplink signal on the established communication link using the reselected communication resource.

11. The method of claim 1, further comprising transmitting an uplink signal on the established communication link using the selected communication resource based on an association between a downlink signal and a downlink resource with the uplink backscattered signal and an uplink resource, wherein the transmission comprises additional information comprising the association.

12. The method of claim 1, wherein the transmission comprises additional information comprising an indication of previously detected devices from the plurality of wireless devices in the communication network.

13. The method of claim 12, further comprising transmitting an uplink signal comprising a reduced payload on the established communication link using the selected communication resource and based on the received indication, wherein the reduced payload comprises a data sequence.

14. The method of claim 13, wherein previously detected devices transmit a reduced payload or do not transmit based on the indication.

15. The method of claim 1, further comprising randomly selecting multiple resources for transmitting repetitions of a transfer block based on the channel sensing metric.

16. The method of claim 15, further comprising including an indication of the resources used to transmit each of the multiple repetitions of the transmitted transfer block.

17. The method of claim 16, further comprising performing successive interference cancellation based on the indication and receiving a repetition of the transfer block.

18. The method of claim 1, wherein the communication resource comprises a time slot and/or a carrier frequency.

19. A device comprising:
one or more processors that are configured to perform:
receiving a transmission comprising a channel sensing metric associated with a communication resource within a communication network for a plurality of wireless devices, wherein the plurality of wireless devices comprises ambient Internet of Things (IoT) devices;
determining whether establishing a communication link with the communication resource comprises a collision with one of the plurality of wireless devices in the communication network based on the received channel sensing metric;
selecting the communication resource based on the determination; and
establishing the communication link using the selected communication resource.

20. A non-transitory computer readable storage medium storing instructions which, when executed by a processor, cause the processor to perform operations comprising:
receiving a transmission comprising a channel sensing metric associated with a communication resource within a communication network for a plurality of wireless devices, wherein the plurality of wireless devices comprises Internet of Things (IoT) devices;
determining whether establishing a communication link with the communication resource comprises a collision with one of the plurality of wireless devices in the communication network based on the received channel sensing metric;
selecting the communication resource based on the determination; and
establishing the communication link using the selected communication resource.
